(19) United States
(12) Patent Application Publication
(10) Pub. No.: US 2001/0038219 A1
(43) Pub. Date: Nov. 8, 2001

(54) HIDDEN STORAGE SYSTEM FOR VEHICLES WITH SIDE PANEL CLOSURE MECHANISM

(76) Inventors: SCOTT CLARE, HAYWARD, CA (US); NEIL G. LONG, HAYWARD, CA (US)

Correspondence Address: L.E. Carnahan, Patent Agent, 4539 S. 1800 West #115, Roy, UT, 84067, US

(21) Appl. No.: 09/455,558

(22) Filed: Dec. 6, 1999

Related U.S. Application Data
(63) Continuation-in-part of application No. 09/082,281, filed on May 20, 1998.
Application No. 09/082,281 is a continuation-in-part of application No. 08/910,516, filed on Aug. 2, 1997, now Pat. No. 5,823,598.
Application No. 08/910,516 is a continuation-in-part of application No. 08/685,678, filed on Jul. 24, 1996, now abandoned.
Application No. 08/685,678 is a continuation-in-part of application No. 08/506,893, filed on Jul. 26, 1995, now Pat. No. 5,567,000.

(51) Int. Cl. B60R 5/00

(52) U.S. Cl. 296/37.6

(57) ABSTRACT

A hidden storage for vehicles such as pickups, trucks, vans and utility/sports, utility and emergency vehicles without altering the external appearance of the vehicle. The hidden storage is located in one or both sides of the vehicle between a rearmost side door and the rear of the vehicle or in the vehicle bed. The hidden storage is accessible only via one or more hinged side panel sections of the vehicle, and access to the interior of the vehicle does not provide access to the hidden storage area. The hidden storage may be provided by a storage box secured to the side of the vehicle and the interior of the storage box is only accessible through opening of an associated hinged section of the side panel of the vehicle, which can be locked shut. The hidden storage may also be provided via a modular construction of the side panels. A mechanism is provided for opening, closing and retaining closed the one or more hinged side panel sections.

### RELATED APPLICATION

This application is a Continuation-In-Part of U.S. application Ser. No. 09/082,281 filed May 20, 1998, which is a Continuation-In-Part of U.S. application Ser. No. 08/910,516 filed Aug. 2, 1997, now U.S. Pat. No. 5,823,598 issued Oct. 20, 1998, which is a Continuation-In-Part of U.S. application Ser. No. 08/685,678 filed Jul. 24, 1996, now abandoned, which is a Continuation-In-Part of U.S. application Ser. No. 08/506,893 filed Jul. 26, 1995, now U.S. Pat. No. 5,567,000 issued Oct. 22, 1996.

### BACKGROUND OF THE INVENTION

The present invention relates to storage systems for vehicles, particularly to hidden storage for vehicles having side panels while maintaining the external appearance thereof, and more particularly to hidden storage for pickups, emergency vehicles, vans, utility and sports utility vehicles without increasing the width or substantially altering the external appearance of the vehicle, and which incorporates mechanisms for opening/closing hinged side panel sections.

Various types of storage/utility systems have been utilized in various types of vehicles, primarily pickups, trucks, and trailers for transporting and/or storing tools, materials, etc. These prior utility beds for pickup trucks are exemplified by U.S. Pat. No. 2,455,417, No. 2,616,754, No. 2,978,153, No. 3,245,713, No. 3,727,971, No. 4,685,695, No. 5,615,922, and No. 5,845,952, all of which have hinged sections exposed to view. In addition, U.S. Pat. No. 3,727,970, No. 3,727,971, No. 4,135,721 and No. 4,394,100 disclose pickup beds provided with hidden storage. Also U.S. Pat. No. 1,990,757 teaches hinging a rear quarter panel to provide access to a compartment but does not teach how the panel is hinged. In addition, recently issued Design Pat. No. 385,224 teaches a utility bed for a pickup wherein the side panels have been widened to cover the wheel wells to provide storage space and includes a compartment above the wheel well and compartments forward and aft of the wheel well with each compartment having an exposed latch mechanism. Recently a hidden storage/utility system has been developed wherein the external appearance or contour of the vehicle has not been changed when compared to the same vehicle without a storage system therein, and the carrying capacity has not been significantly reduced. This hidden storage/utility system for pickup and truck beds and trailers is described and claimed in above referenced U.S. Pat. No. 5,567,000. Also, above referenced U.S. Pat. No. 5,823,598, referenced above, entitled Hidden Storage For Vehicles describes and claims hidden storage systems for vans, utility and sports utility vehicles as well as modifications of the hidden storage arrangement of U.S. Pat. No. 5,567,000. Fabrication of the hidden storage system may be carried out, for example, as described and claimed in U.S. Pat. No. 5,819,390 and No. 5,784,436, and copending U.S. application Ser. No. 08/896,388 filed Jul. 18, 1997 and Ser. No. 09/183,851 filed Oct. 30, 1998.

The hidden storage system of U.S. Pat. No. 5,567,000, for example, basically involved providing storage adjacent the wheel well area along part or the entire length of the bed and providing, for example, the fender/side panel of the bed with a hinged side panel section with a closure mechanism, such as a lock/latch arrangement, whereby the fender/side panel can be raised to expose the storage area or closed and latched to conceal the storage area. In the closed position, the external appearance is substantially the same as an identical vehicle without the hidden storage capability. Thus, by use of the hidden storage system, the vehicle can be parked in areas where theft would likely occur from conventional storage systems.

Like pickups, trucks and trailers, there is small to no hidden storage in emergency vehicles, vans, utility vehicles and sports utility vehicles. Any hidden storage in such vehicles is in the interior thereof and access to the interior provides access to the hidden storage areas. Thus, theft from such vehicles is carried out by merely obtaining access to the interior thereof. To prevent potential theft, valuables must be removed from the vehicle and/or expensive alarm systems must be added. Thus, there has been a need for safe, readily accessible hidden storage in emergency vehicles, vans and utility/sports vehicles.

This need for hidden storage for such vehicles has been resolved by the present invention which involves an extension of the hidden storage system of the above-referenced U.S. Pat. No. 5,567,000 and No. 5,823,598 by applying the principles of that hidden storage system to emergency vehicles, vans, utility vehicles and sports utility vehicles wherein side panel sections of the vehicle are hinged and provided with storage areas which are accessible upon outward movement (upward, downward or sidewise) of the hinged side panel sections. In addition to the interior of the emergency vehicle, van, utility and/or sports utility vehicles which provide storage but the storage is readily accessible to theft, the present invention provides hidden storage (a trunk) for such vehicles with no or minimum altering of the external appearance of the side panels of the vehicle and which is readily accessible to the owner but not readily accessible to theft. The hidden storage system of this invention can be fabricated via a conversion method, a modular assembly method or an assembly line method. The closure mechanisms for the hinged side panel sections may be of a gear type, hydraulic, screw type or the lock/latch type.

### SUMMARY OF THE INVENTION

It is the object of the invention to provide hidden storage for vehicles without noticeable alteration of the width of or the external appearance of the vehicles.

A further object of the invention is to provide hidden storage for pickups, emergency vehicles, vans, utility vehicles and sports utility vehicles and to provide heating means for doors of the vehicle and storage system.

A further object of the invention is to provide hidden storage for vehicles utilizing hinged sections of the fender/side panels of the vehicles and closure means therefor.

Another object of the invention is to provide a van, utility vehicle, sports utility vehicle or emergency vehicle with safe, readily accessible hidden storage with a hinged side panel or side panel sections such that is not accessible by mere access to the interior of the van or emergency/utility/sports vehicle and means for retaining the hinged sections closed.

Another object of the invention is to provide a vehicle with a hidden storage area along at least one side of the vehicle that is accessible only by outward movement of at least one hinged section of a side panel or fender/side panel of the vehicle without altering the normal external appearance of the vehicle and provide mechanisms for moving the hinged section outwardly.

Another object of the invention is to provide hidden storage for a truck, van, emergency, utility or sports utility vehicle which may, for example, extend along the entire length or along a partial length of the vehicle from a door to the rear of the vehicle and which is accessible only via one or more hinged or sliding sections of the side panel or fender/side panel of the vehicle, with only minor modification of the external appearance of the vehicle, and to provide closure means for the hinged side panel or side panel sections.

Other objects and advantages of the present invention will become apparent from the following description and accompanying drawings. Basically, the invention involves providing hidden storage for vehicles, particularly for trucks, vans, emergency, utility and sports utility vehicles, without extending the width of a conventional vehicle, with only minor alteration of the normal external appearance of the vehicle, and with closure mechanisms for side panel sections of the vehicle. The minor alteration of the normal external appearance involves only thin vertical and/or horizontal lines in the side panels or fender/side panels which define the edge or edges of the hinged side panel sections, the hinges for the side panel sections being hidden with a closure mechanism being hidden and controlled from the rear of the storage area, for example, or by electrical control from a key or keyless control in the vehicle whereby the control for the closure mechanism may be located anywhere on or in the vehicle. Due to the width of a normal vehicle side panel or fender/side panel, which may consist of an outer and an inner panel, removal of all or a portion of the inner panel, hinging of the outer panel or one or more sections thereof and positioning of a narrow storage box or storage area defining component having its only opening adjacent the removed inner panel provides adequate storage space for long items such as snow or water skis, ski poles, surf board, rifles, etc., as well as for storage of emergency type supplies, etc., as well as for camping/sports equipment or for materials or tools utilized in various trades. The narrow storage box or storage area, which may be as wide as the wheel wells of the vehicle or narrower, results in only a small loss of interior space along the interior of one or both sides of the vehicle. The storage area or box may be fabricated as a module with the side panel. By way of example, using a conventional van having only a driver door on the left side of the van, the hidden storage could extend from adjacent the driver's door to the rear of the van, the storage box or area being configured, for example, to conform to the floor and any wheel well area of the van or can be located above the wheel well, if desired. With the storage box or compartment forming the storage area being welded or otherwise secured to the side of the van, the only access to the interior of the storage area is via one or more hinged portions of the outer panel section of the side panel or fender/side panel, depending on the external configuration of the vehicle. By use of hidden hinges and hidden latch or closure mechanisms which are commercially available and capable of withstanding 1,500 pounds pry pressure and controlled by conventionally available lock or activation systems, the only changes in the exterior appearance of the side panel of the vehicle may be narrow lines along the vertical and/or horizontal edges of the hinged side panel section or sections, but in some embodiments the entire side panel may be hinged. The hinged side panel sections are provided on the interior surfaces with sufficient support members and with insulation/sound absorbing materials. The opening or openings in the side panels are provided with seals similar to car trunk lid seals such that when the hinged side panel sections are closed, water/dust cannot enter the hidden storage area. Recently, anti-frost seals have been developed for vehicles operating in extremely cold climates, as exemplified by copending U.S. application Ser. No. 09/082,436 filed May 20, 1998 entitled “Vehicle Compartment Seals”. Also, the door or side panel locks may be insulated and/or heated to prevent freezing.

The hidden storage arrangement provided by this invention enables numerous types of vehicles to be built or modified to include one or more hidden storage compartments which are accessible only via one or more hinged side panel sections of the vehicle, and with the hinged side panel(s) closed, the storage compartments are not easily identified because of the minor or no modification in the exterior surface of the vehicle and have no exposed lock/latch mechanisms. The hidden storage can be incorporated into a vehicle by conventional assembly line techniques, modular fabrication and assembly, or conversion or retrofitting an existing vehicle.

### BRIEF DESCRIPTION OF THE DRAWINGS

The accompanying drawings which are incorporated into and form a part of the disclosure illustrate embodiments of the invention and, together with the description, serve to explain the principles of the invention.

FIGS. 1 and 2 illustrate a side view and plan view of a bed of a hidden storage system of a pickup truck generally similar to that described and illustrated in above referenced U.S. Pat. No. 5,567,000.

FIG. 3 is a view similar to FIG. 2 and including a collapsible beam support system under the floor of the bed.

FIG. 4 illustrates a bed similar to FIG. 3 composed of modular assemblies and which includes the collapsible beam support system of FIG. 3.

FIG. 5 is a perspective view of a hidden storage system in a van in accordance with the present invention.

FIG. 6 is a side view of a four-door utility vehicle with a hidden storage system in accordance with the present invention.

FIG. 7 is a side view of a two-door sports utility vehicle with a hidden storage system incorporated therein according to the present invention.

FIG. 8 is a side view of a pickup bed having three hinged side panel sections, with one hinged section including the taillight assembly.

FIG. 9 illustrates a side view of a vehicle similar to FIG. 5 but with the lower edge of the hinged side panel section being located above a decorative strip which extends along the lower edge of the side panel and wheel well.

FIG. 10 illustrates a side view of an emergency vehicle with a hidden storage system mounted therein and above the wheel well.

FIG. 11 illustrates a side view of a commercial or large van with a hidden storage system mounted therein, and with the hinged side panel located above the wheel well and extending from the driver's side door to the rear end and including the taillight.

FIG. 12 illustrates an embodiment of a modular side panel including the hidden storage area, similar to FIG. 4, and includes an adjustable and/or sliding shelving arrangement in the storage area of the side panel.

FIG. 13 illustrates another embodiment of a modular side panel using spring type hinges, slideable shelves and additionally including storage behind the trim panels, having a cover thereover.

FIG. 14 illustrates a conventional pickup truck bed wherein the side panels have inner and outer panels, with a portion of the inner panel removed and the outer panel hinged.

FIG. 15 illustrates an embodiment of a bed, such as shown in FIG. 14, which includes a hidden storage area on each side with vertically hinged sections, with the front hinged sections including the inner and outer panels and the rear hinged section comprising only the outer panel.

FIGS. 16 and 17 illustrate embodiments of a pickup truck bed having a hidden storage system with various hinged side panel section arrangements, and wherein FIG. 17 illustrates sliding compartments located over the wheel well.

FIGS. 18 and 19 schematically illustrate mechanical and electrical closure mechanisms composed of latch/lock arrangements for the hinged side panels.

FIGS. 20 and 21 illustrate embodiments of strut assemblies for the hinged side panels, with FIG. 21 including a heating arrangement.

FIG. 22 illustrates an embodiment of a closure mechanism comprising a motor/gear mechanism for opening and closing the hinged side panel of a hidden storage system of a vehicle, such as shown in FIGS. 1-11.

FIG. 23 illustrates another embodiment of a closure mechanism for a hinged side panel comprising a torque/spring mechanism.

FIGS. 24 and 25 illustrate another embodiment of a motor/gear closure mechanism with the panel in the closed and open position, using the motor/gear closure mechanism similar to that of FIG. 22.

FIGS. 26 and 27 illustrate a modular side panel/storage area assembly, such as shown in FIGS. 4, 12 and 13, using the closure mechanism of FIG. 22 in closed and open positions.

FIGS. 28 and 29 illustrate the embodiment of FIGS. 26 and 27 but which incorporate at least one strut assembly, such as shown in FIGS. 29 and 20, to stabilize the hinged side panel when in open position of FIG. 29.

FIG. 30 illustrates another closure mechanism for a hinged side panel comprising a hydraulic cylinder arrangement.

FIG. 31 illustrates a closure mechanism for a hinged side panel composed of a motor driven screw arrangement.

FIG. 32 is a cross-sectional view of a modular side panel/storage area illustrating a module component connection and a module to floor connection.

FIGS. 33 and 34 are enlarged illustrations of the connections of FIG. 32.

FIG. 35 illustrates an embodiment of a bed similar to FIG. 14 but including a hidden storage area, vertically hinged side panel sections and U-shaped support members for the floor and side panels, and may be integral structural components as molded composite.

FIG. 36 is a perspective view of a truck with a unified cab and bed which incorporates a hidden storage system on both sides of the bed and utilizing at least one hinged side panel section and a sliding side panel section.

FIGS. 37A and 37B are top views of a sliding panel section similar to that of FIG. 36 showing the open and closed positions.

FIG. 38 illustrates an insulated/heated lock arrangement for a latch mechanism of a hinged side panel of the hidden storage system.

FIG. 39 illustrates a heating arrangement for the cylinder of a lock for any door or side panel section.

### DETAILED DESCRIPTION OF THE INVENTION

The present invention is directed to hidden storage for vehicles such as pickups, trucks, vans and emergency/utility/sports utility vehicles without increasing the width of the vehicle or substantially altering the external appearance of the vehicle and includes closure mechanisms for the hinged side panels of the storage system. The hidden storage for vehicles as provided by the present invention basically involves providing the vehicle with one or more storage areas located adjacent one or more side panels or fender/side panels of the vehicle, hinging at least one section of the one or more side panels or fender/side panels whereby the hinged section can be opened to expose the interior of the storage area, and providing mechanisms for retaining the hinged side panel sections in an open or closed position. The only alterations of the external appearance of the vehicle, with the exception of FIGS. 4, 12 and 13, are the narrow vertical and/or horizontal cuts defining the edges of the hinged side panel section or sections, the hinges and closure mechanisms being hidden from an external view of the vehicle, except for an optional key slot.

Vans, both passenger and commercial, as well as emergency vehicles, utility vehicles and sports utility vehicles are widely utilized in various fields of work, play and vacations. A common problem, as pointed out above, with vans and emergency/utility/sports utility vehicles is a lack of hidden storage space (no trunks). Once access to the interior of such a vehicle is made, one also has access to any hidden storage areas therein.

In recent years, utility vehicles, such as the Suburban made by General Motors Corporation, sports utility vehicles such as the Bronco, Explorer or Excursion made by Ford Motor Company, and vans (both mini and full size) such as the Caravan made by Chrysler Corporation, have been popular vehicles for both work and personal use. Also, emergency vehicles, both of the van type and the truck type (cab and bed) regardless of size, have no hidden (trunk type) storage, and access to the interior thereof enables one to any medical supplies or equipment, drugs, etc. which may need to be carried in emergency vehicles. Hereafter the term vehicle is intended to include all such vehicles and the term side panel includes all contoured or straight non-contoured sides of such vehicles with or without fender sections. Many of these vehicles are equipped with four wheel drive and thus are widely used for camping, ski outings and emergency applications. However, a drawback of these vehicles is a lack of secure storage space particularly, for example, when families of four to six people travel. As a result, on ski outings, for example, the skis, ski poles, etc. are mounted on the top of the vehicle and are thus exposed to the environment and theft. If, for example, skis, etc. are to remain with the vehicle overnight, safety and security requires that the skis, etc. be removed from the top of the vehicle and placed inside the vehicle. Many emergency type vehicles need to carry equipment which takes up considerable interior space, as well as medical supplies, etc. which are accessible to theft. Mere breakage of a window in a vehicle, for example, enables access to the interior thereof and theft of the skis, equipment, and other valuables in the vehicle interior.

By incorporation of the hidden storage system into such vehicles, skis, ski poles, etc., or water skis, surf boards, emergency equipment supplies, electronics, cameras, etc., for example, may be safely stored in the vehicle and thus one gaining access to the interior of the vehicle does not have access to the storage area. Access to the storage area is only through a hinged/locked side panel section of the vehicle. Most vehicles of the type considered herein have sufficient length between a door and the rear of the vehicle to enable incorporation of the hidden storage area without adversely affecting the interior space of the vehicle. Also, by the elimination of exposed closure mechanisms, the storage compartments are not readily recognized by those inclined toward theft. While the addition of a key slot for the hinged side panel sections has been shown, such would reduce the hidden advantages of the storage system and increase the potential for theft therefrom. Thus, while the hidden storage/utility system of the above-referenced U.S. Pat. Nos. 5,567,000 and 5,823,598 provide a “truck-with-a-trunk” for a vehicle bed, the present invention provides trailers with side panels, vans and emergency/utility/sports utility vehicles with a trunk, a hidden storage area, with no or only minor alterations to the external appearance thereof. Note that, as shown in FIG. 2, the side panels 15 include a fender 28. The hidden storage also serves to provide means to remove and store unrestrained articles from inside the vehicle, thereby improving passenger safety. The hidden storage may be incorporated above the wheel well or forward of, rearward of and above the wheel well, and below the floor, or combinations thereof.

The hidden storage system of the present invention may be fabricated from various materials including metals, fiberglass, reinforced plastics and combinations thereof as these various materials are now commonly utilized for various components in vehicle manufacturing.

The hidden storage may be incorporated by various methods such as by an assembly line method or a conversion (retrofit) method similar to the techniques described and claimed in above referenced U.S. Pat. No. 5,784,436 and No. 5,819,390. Also, the components for the hidden storage system may be fabricated and/or assembled using a modular method similar to the technique described and claimed in copending U.S. application Ser. No. 08/896,388 filed Jul. 18, 1997 entitled “Hidden Storage/Utility System Modular Fabrication Method”.

While the invention is illustrated and described hereinafter for a pickup, van, emergency or utility vehicle, it can be incorporated into most vehicles of the type described above, it being recognized that vehicles having two doors on each side rather than a single door leaves less length between the rear door and the rear of the vehicle and thus less space for hidden storage. Also, vehicles designed for the carrying of passengers, which include windows along the side, provide less space for incorporation of the hidden storage system than similar vehicles not designed for passenger use.

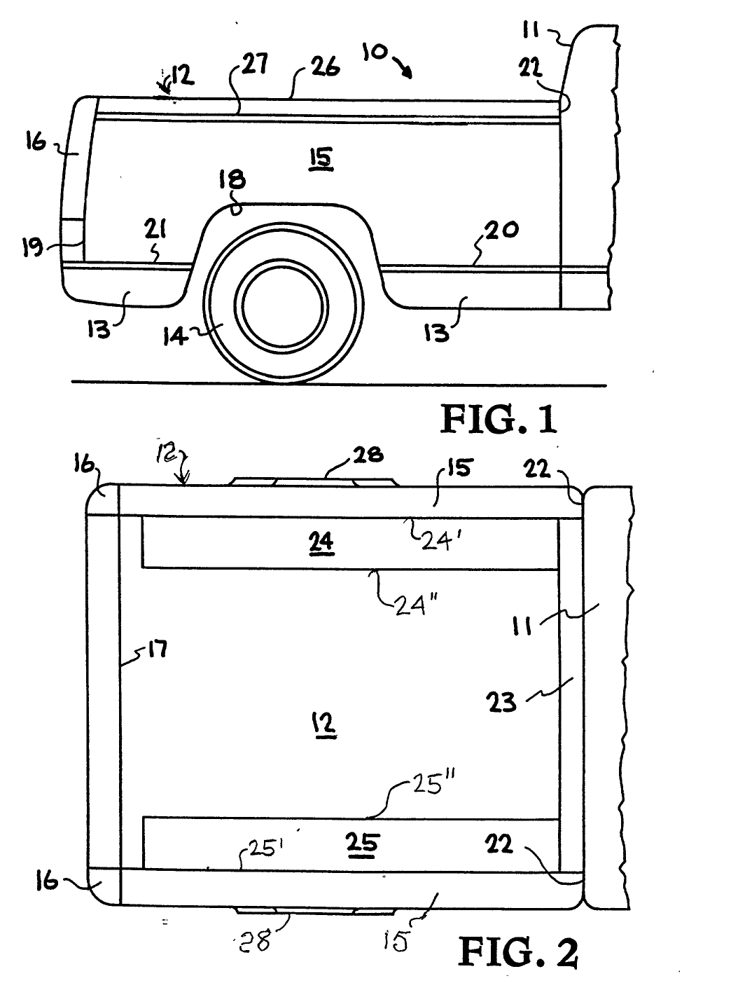

In view of the extension of the hidden storage system of above referenced U.S. Pat. Nos. 5,567,000 and 5,823,598 to vans and emergency/utility/sports utility vehicles, again referred to hereinafter generically as vehicles, FIGS. 1 and 2 illustrate side and plan views of the hidden storage system incorporated into a bed of a pickup truck. As seen in FIG. 1, from a side view the only alteration to the normal exterior side panel appearance is the single vertical line or cut indicating the rear edge of the hinged side panel, the front edge of the hinged side panel extending to the front of the bed. In configurations such as shown in FIGS. 4, 12 and 13, the taillight section is incorporated into the hinged side panel. The hinge for each side panel is located on an inner area of the side panel along the upper section thereof or along a vertical section of the side panel so as not to be exposed to one viewing the bed from an external side position. Thus one would not readily recognize the modification of the bed and therefore those with intent to steal tools, valuables, etc. from the vehicle would not recognize the hidden storage arrangement.

Referring now to the drawings, FIGS. 1 and 2 illustrate a conventionally appearing pickup truck, generally indicated at 10, having a cab 11, bed 12, trim panels 13, wheels 14 (one shown), and hinged side panels 15, a taillight arrangement 16, a hinged tailgate 17 and wheel wells 18. However, the bed 12 of FIGS. 1 and 2 has been modified in accordance with the present invention with the only indication of such modification being the cut, small space or lines 19 in the side panels 15 below taillight 16, as shown in FIG. 1, with the side panel being closed. Note that in this embodiment the hinged side panels 15 terminate adjacent the trim panels 13 secured to the frame or undercarriage, as indicated by the lines 20 and 21, and the front edges of the hinged bed side panels are indicated at 22 where the side panels 15 contact a front panel or bulkhead 23 of the bed 12.

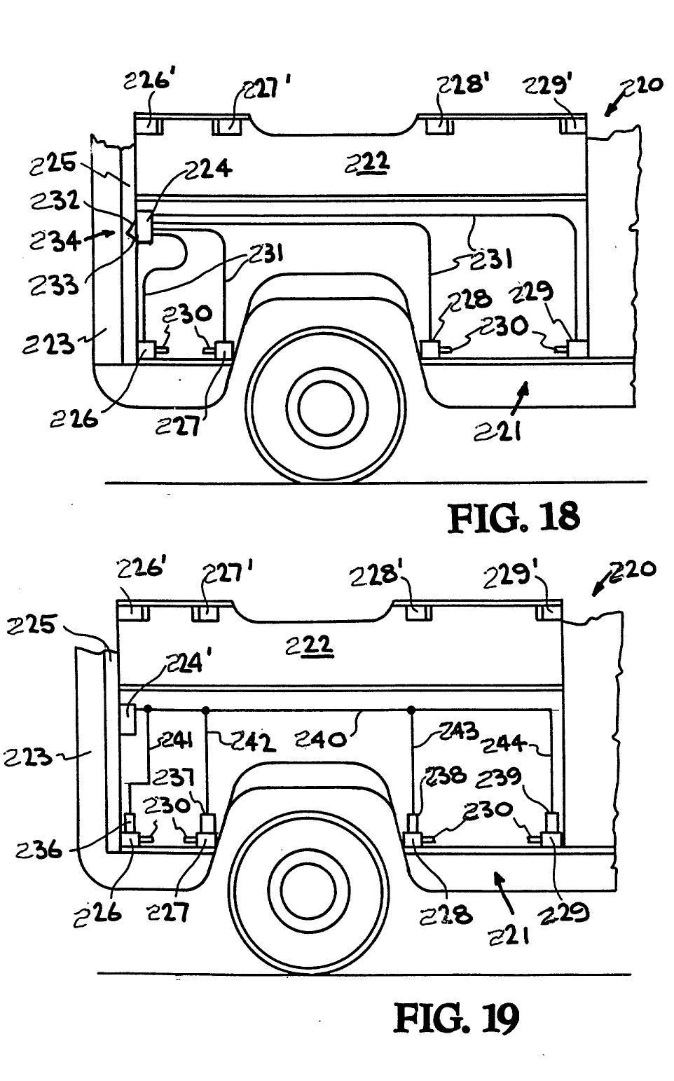

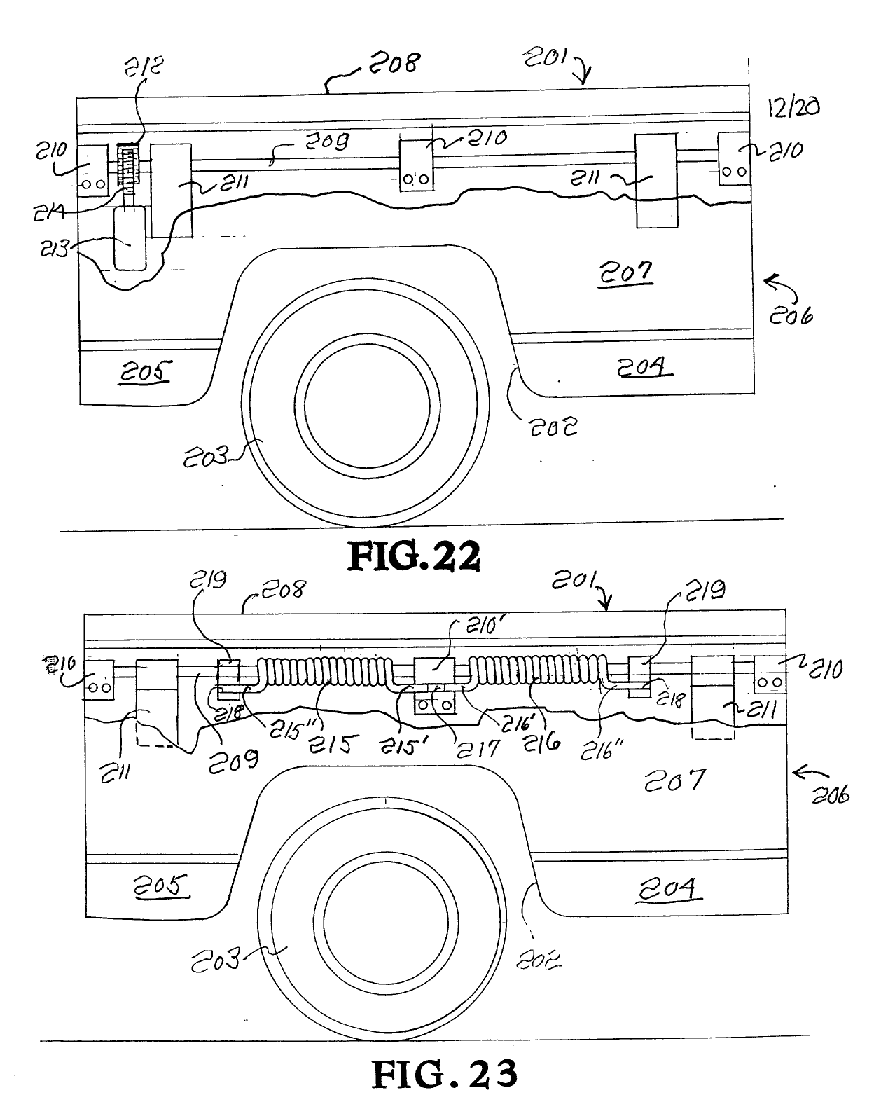

As seen in FIG. 2, the hidden storage area is composed of a storage area or structure boxes 24 and 25 mounted within the bed 12 between the side panels 15, and forward, rearward and over the wheel wells 18, the boxes 24 and 25 being constructed to cover the wheel wells 18 but not extend to the top or upper surface or upper rail 26 of bed 12 so as not to be seen from an external view, and terminate in spaced relation to tailgate 17, but may terminate adjacent the tailgate. The top of the storage boxes extend along the bed at a height equal to line 27 in FIG. 1. Side panels 15 include a fender section 28. Storage boxes 25 and 26 are secured to the side panels as indicated at 24′ and 25′ and to the bed floor as indicated at 24″ and 25″ by welding, bonding, etc. A lock mechanism is mounted in the rear of each of boxes 24 and 25 and activates closure or latch mechanisms, which may include latch members located in spaced relation along the bed 12, and which cooperate with corresponding latch members in side panel 15, as shown in FIGS. 18 and 19. As seen in FIG. 18, the latch members are interconnected by a cable which is connected to the lock mechanism or are connected electrically, as shown in FIG. 19. The latch mechanism of FIGS. 18 and 19 may be replaced with other types of closure mechanisms such as shown in FIGS. 22, 23 and 28-31.

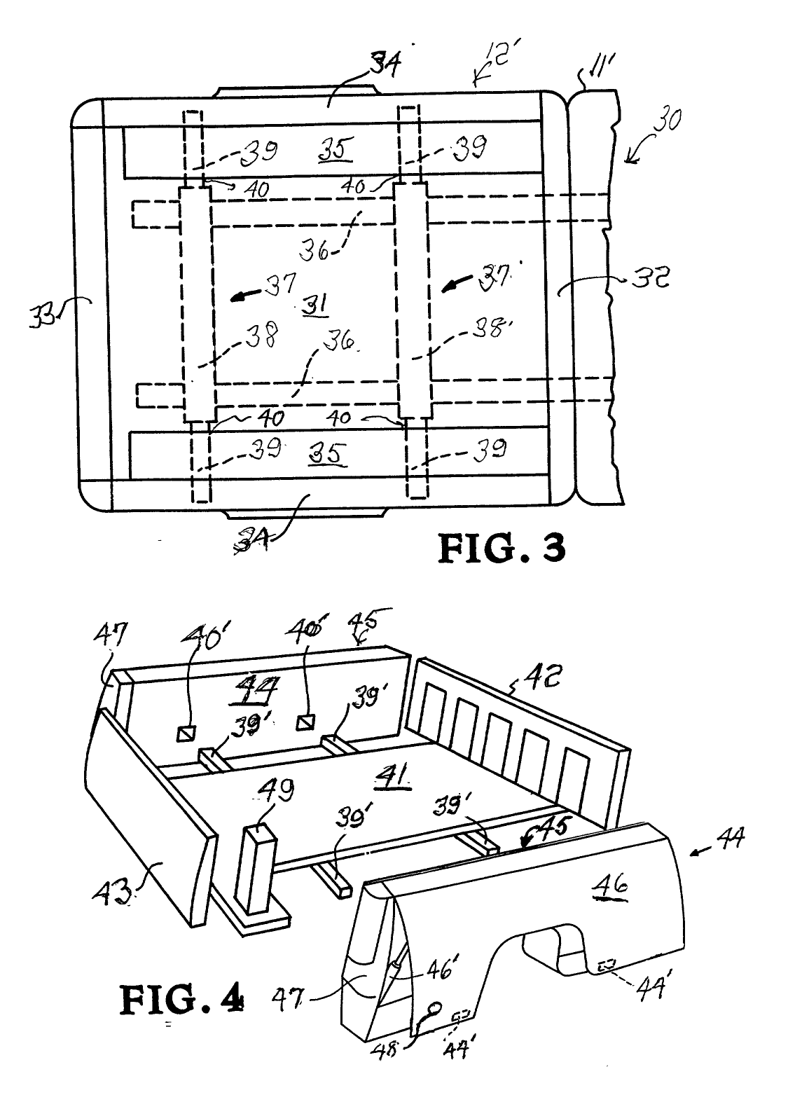

FIG. 3 illustrates a vehicle bed similar to that of FIG. 2 which comprises a bed 12′ mounted on a pickup 30 having a cab 11′, with bed 12′ including a floor 31, a bulkhead 32, a tailgate 33 and side panels 34 having storage areas or boxes 35 secured to or integral with side panels 34. The bed 12′ is mounted on frame members 36 and positioned intermediate to bed 12′, and frame members 36 are a pair of collapsible support beams 37 designed to collapse upon a side impact above a certain magnitude. The collapsible support beams 37 are composed of a central section 38 and end sections 39 which extend into and are secured in central sections 38 as by a breakable connection such as spot welding. The end sections 39 extend through openings 40 in storage areas or boxes 35. The internal opening of center section 38 and the matching external shape of end portions of end sections 39 may be of a circular, square or rectangular configuration, for example.

FIG. 4 illustrates a bed similar to bed 12′ of FIG. 3 constructed of modular assemblies composed of a floor assembly 41, a bulkhead assembly 42, a tailgate assembly 43 and a pair of side panel assemblies 44 which include a storage area 45 and hinged side panel section 46, with strut assembly 46′ and a closure mechanism 44′. Modular side panel assemblies 44 include openings 40′ for end sections 39′ of collapsible support beams located under the bed, as in FIG. 3. The side panel assemblies 44 also include a taillight assembly 47 and a key slot 48, which is preferably omitted. Side panel assemblies 44 are mounted to posts or support members 49 (only one shown) of floor assembly 41 and are secured to the bulkhead assembly 42.

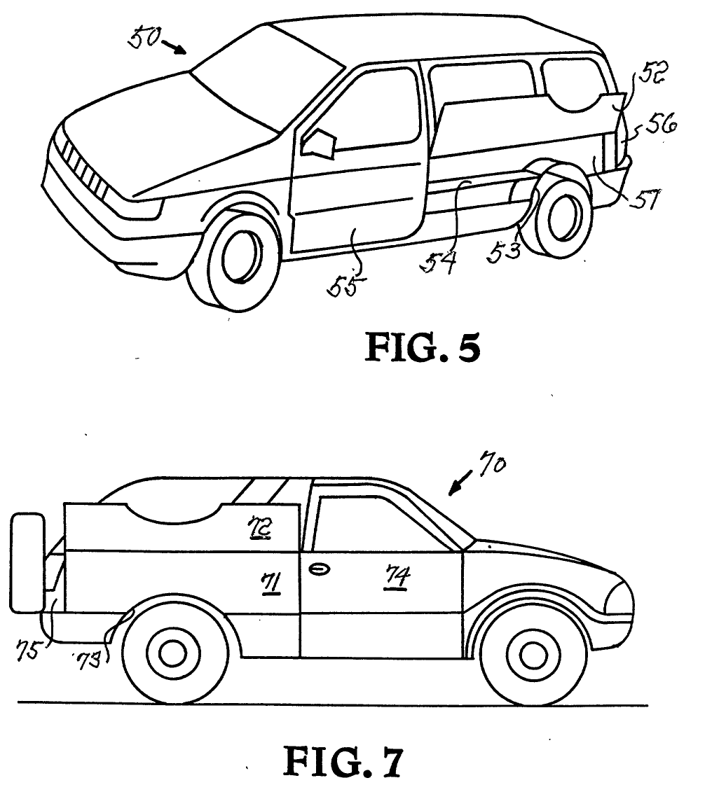

FIG. 5 illustrates a van, such as a conventional three-door van, with a hidden storage system incorporated on the left or drivers side. While the van is illustrated as a passenger type having windows along the side and generally having a third door on the opposite or passenger side and a rear door, the hidden storage system can be incorporated into commercial type vans of various types which may not include windows on the sides and may include only two doors plus a rear door. The interior of the van incorporating the hidden storage includes a storage box which extends along the interior side of the van adjacent the hinged side panel sections as in the FIGS. 1-2 embodiment, the width and height of the storage box being varied in accordance with various needs.

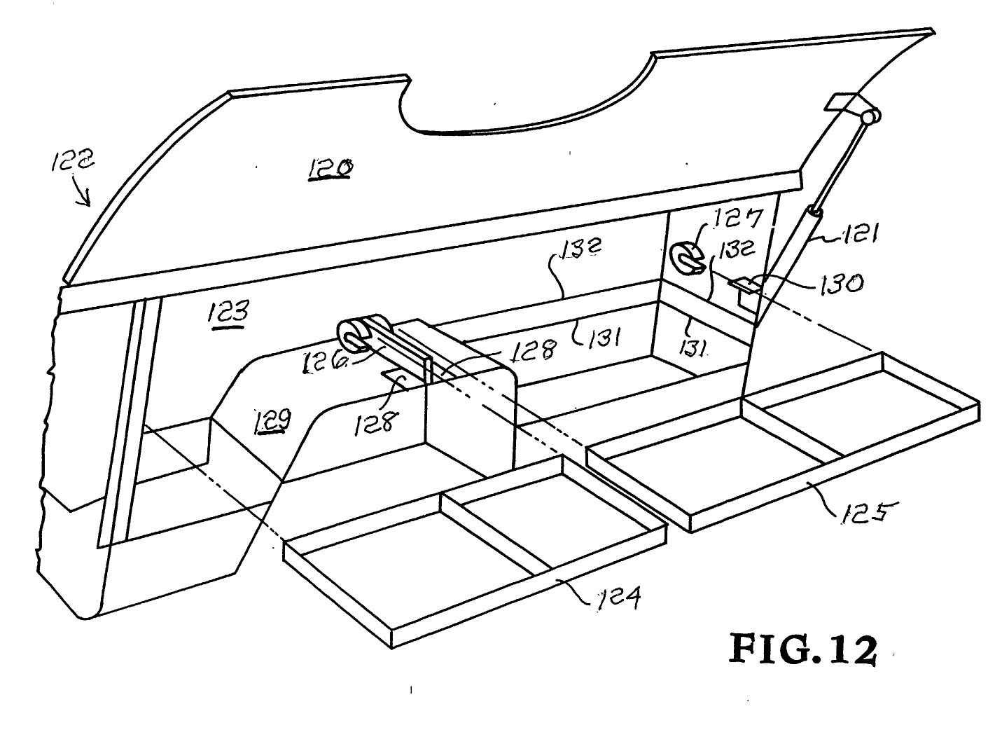

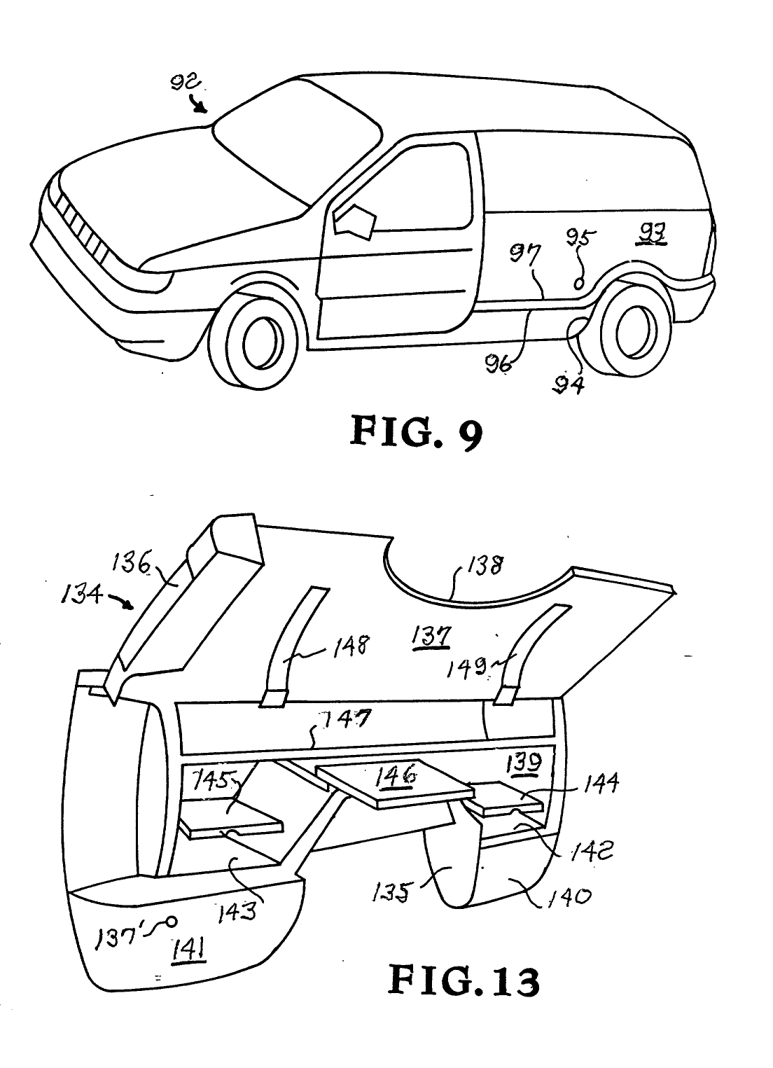

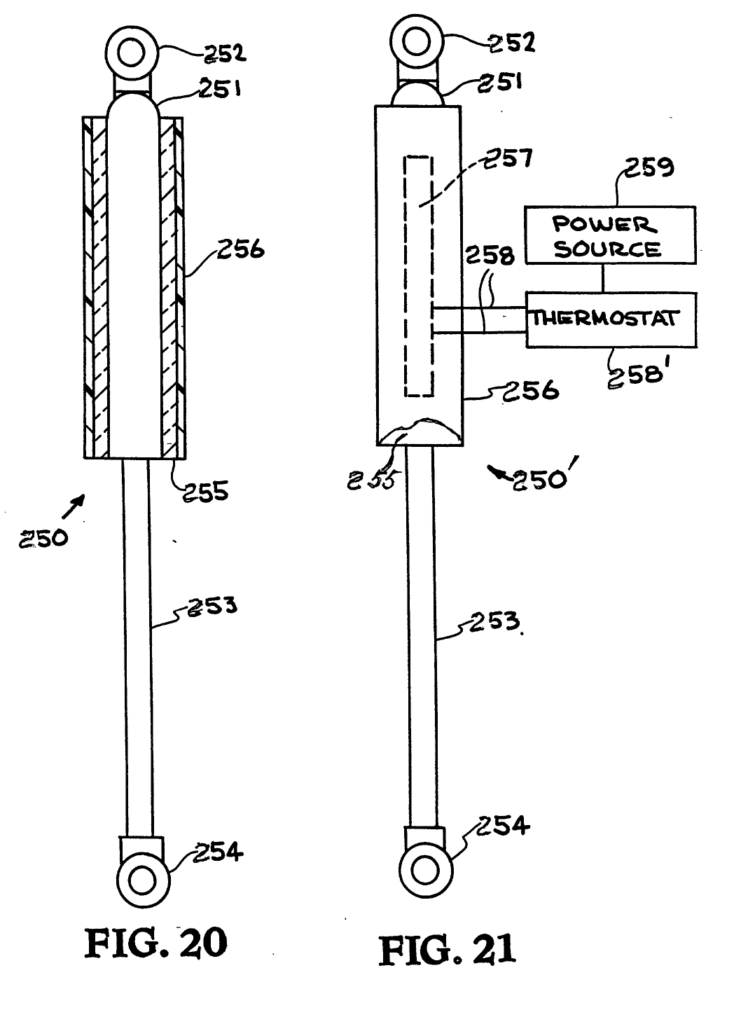

As shown in FIG. 5, the van generally indicated at 50, such as a Dodge Caravan, is either initially assembled or modified (retrofitted) to include a storage box 51 and a hinged side panel section 52, with the storage box 51 and side panel section 52 being configured to extend over and around a rear wheel well 53 of van 50. The storage box 51 is provided with at least one shelf, as shown at 54, which may be of an adjustable type and/or slideable type. A seal assembly is utilized to seal out moisture and/or dust when the side panel section is closed, and the side panel section includes support members, as in the embodiment of FIGS. 1-2. In FIG. 5, the storage box 51 and hinged side panel section 52 extend from a point behind the driver's side door 55 to a point ahead of the rear 56 of van 50, and the side panel section 52 is hinged to raise upwardly. However, as described and illustrated hereafter with respect to FIGS. 9-12, the hinged side panel section(s) and/or storage box(s) may be located along only portions of the vehicle's side and/or may be split or hinged downwardly, sidewise and/or upwardly. The hinges need not extend along the entire length of the hinged side panel section. Also, as illustrated with respect to the FIGS. 1-2 embodiment and described hereinafter and illustrated in greater detail with respect to the FIGS. 18-19 embodiments, the hinged side panel section of FIG. 5 is provided with a lock/latch mechanism of either a mechanical or electrical type. Also, the hinged side panel section of FIG. 5 is provided with a strut assembly to retain the side panel section in open position, as described in greater detail relative to FIGS. 20 and 21. In addition, the shelving arrangements of FIGS. 12 and 13 may be utilized in the FIG. 5 embodiment. While not shown, an appropriate seal may extend around the opening in the side panel, similar to a trunk seal. Such seal assemblies are described and claimed in copending application Ser. No. 09/082,436 filed May 20, 1998 and entitled “Vehicle Compartment Seals”.

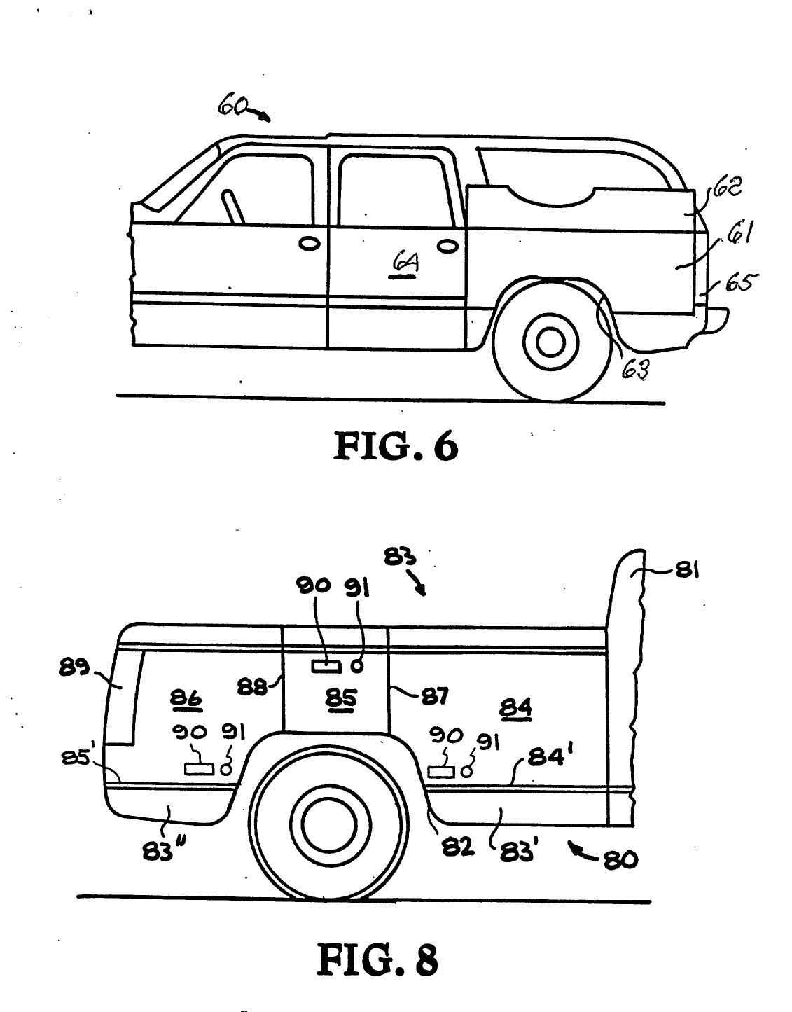

FIG. 6 illustrates a four-door utility vehicle, such as a Chevy Suburban, with a hidden storage system incorporated between the rear side door and the rear of the vehicle on at least one side. The utility vehicle indicated at 60 includes a storage box 61 and a hinged side panel section 62 which are constructed to extend over a wheel well 63 intermediate rear side door 64 and the rear end 65 of the vehicle, as described above. While no shelving is shown in FIG. 6, one or more shelves of different types, such as shown in FIGS. 12 and 13, for example, may be installed in the interior of storage box 61. The hinged side panel sections may be in various configurations, as described with respect to FIGS. 1, 8, 12, 16 and 17. Also, as described above with respect to FIG. 5, lock/latch mechanisms and strut assemblies are incorporated to lock, release and retain the hinged side panel section 62. An appropriate moisture and dust seal is utilized about the edge of the hinged side panel section when closed, and the inner surface of the side panel section may be coated with insulation and/or sound absorbing materials. Also, appropriate structural supports are fixed to the inner surface of the hinged side panel section.

FIG. 7 illustrates the hidden storage system incorporated into a two door sports utility vehicle, such as a Ford Explorer, Chevy Blazer, etc. The vehicle indicated at 70 includes a storage box 71 and a hinged side panel section 72 which extend over a wheel well 73 and are located intermediate a passenger side door 74 and a rear end 75 of vehicle 70. As in the embodiments of FIGS. 5 and 6, the storage box and/or hinged side panel section includes shelves, insulation/sound materials, supports, a lock/latch mechanism and strut assemblies. Also, as described above and in greater detail with respect to FIGS. 1, 8, 12, 13 and 16-17, for example, various configurations of the storage box and/or hinged side panel sections and shelving arrangements may be utilized.

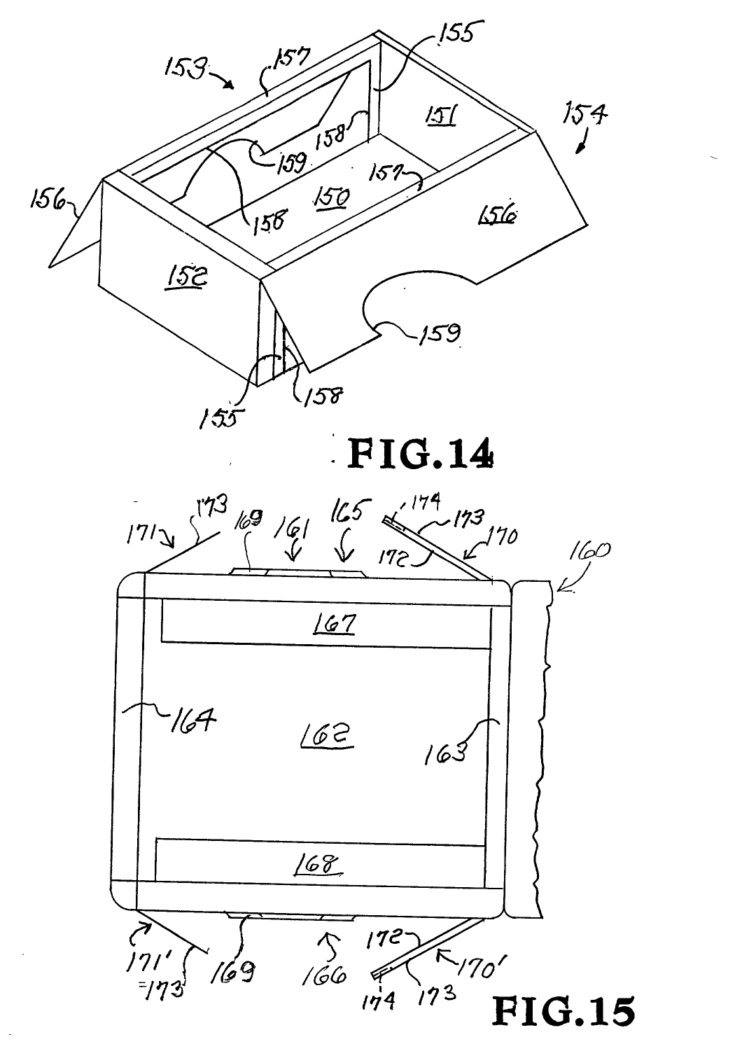

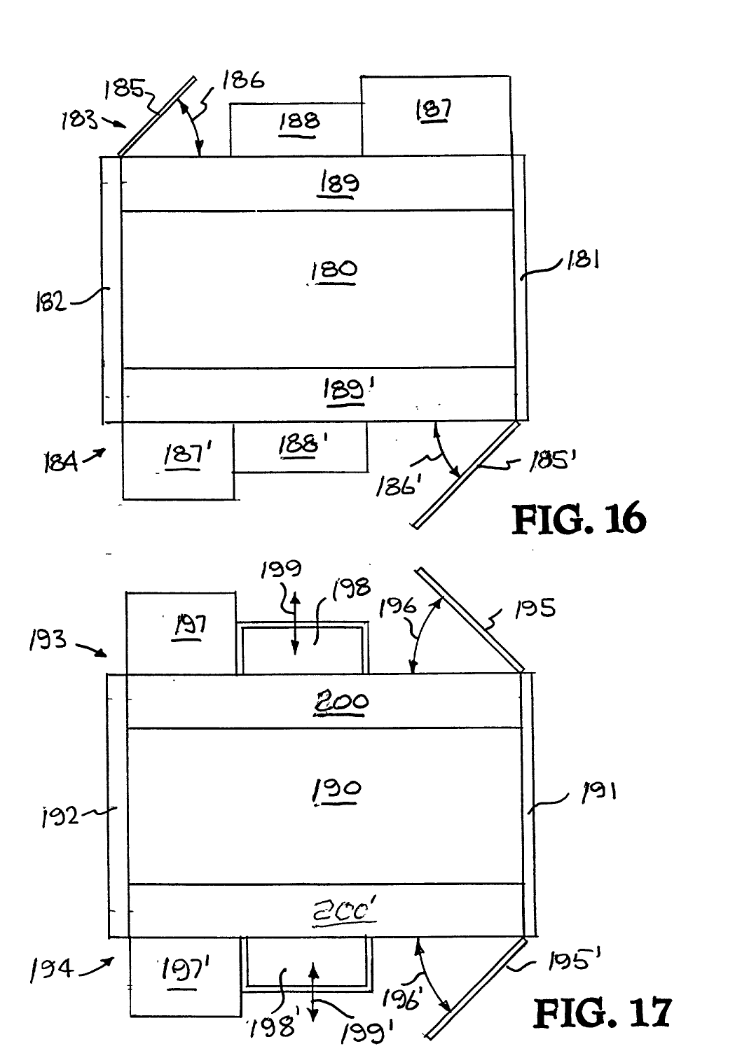

FIG. 8 illustrates an embodiment of a pickup bed similar to FIGS. 1 and 2, with a hidden storage system mounted in the side panels thereof but with three hinged side panel sections and wherein the taillight assembly moves with the rearmost hinged side panel section. The bed, indicated generally at 80, is mounted on a frame (not shown) connected to a cab 81, and includes wheel wells (only one shown) at 82. The storage system of FIG. 8, while not shown, includes a storage box as in FIGS. 1-2 and a lock/latch mechanism as shown in FIGS. 18-19. The bed 80 includes side panels, generally indicated at 83, on each side (only one shown) and each or either of which include three hinged sections 84, 85 and 86, with hinged section 84 extending from the front edge of the side panel to an area above the wheel well 82 as indicated by vertical cut line 87, hinged section 85 being located above wheel well 82 and defined by cut line 87 and another vertical cut line 88, with hinged section 86 extending from cut line 88 to the rear end of bed 80 and including taillight assembly 89. Each of hinged sections 84 and 86 may be hinged horizontally or vertically so as to open upwardly, downwardly or sideways, and may terminate along lines 84′ and 85′ or extend to the bottom of side panel sections 83′ and 83″. Hinged section 85 is hinged horizontally and thus can be either raised or lowered. If section 85 is hinged at a lower end, it can be designed on the inner surface thereof to provide a work bench, and if hinged at the upper end, one or more slideable compartments or shelves, as described hereinafter with respect to FIGS. 12 and 13, may be mounted behind the hinged section 85 of the side panel or, if desired, can be hinged to open downwardly with slideable shelves or compartments located therebehind. Also, if desired, the three hinged side panel section arrangement of FIG. 8 can be modified as described hereinafter with respect to FIGS. 16-17. While not shown, the storage box on each side of bed 80 may have a height equal to the height of the side panels 83, or may have a height less than the height of the side panels, as in the embodiment of FIGS. 1-2. Hinged sections 84, 85 and 86 may be optionally provided with a flush type handle latch or handle 90 and a key lock 91, but unexposed latch and lock means as shown in FIGS. 13 and 14 are preferred. If desired, the closure mechanisms of FIGS. 22, 23 and 28-31 may be used in place of the lock/latch mechanisms of FIGS. 18-19.

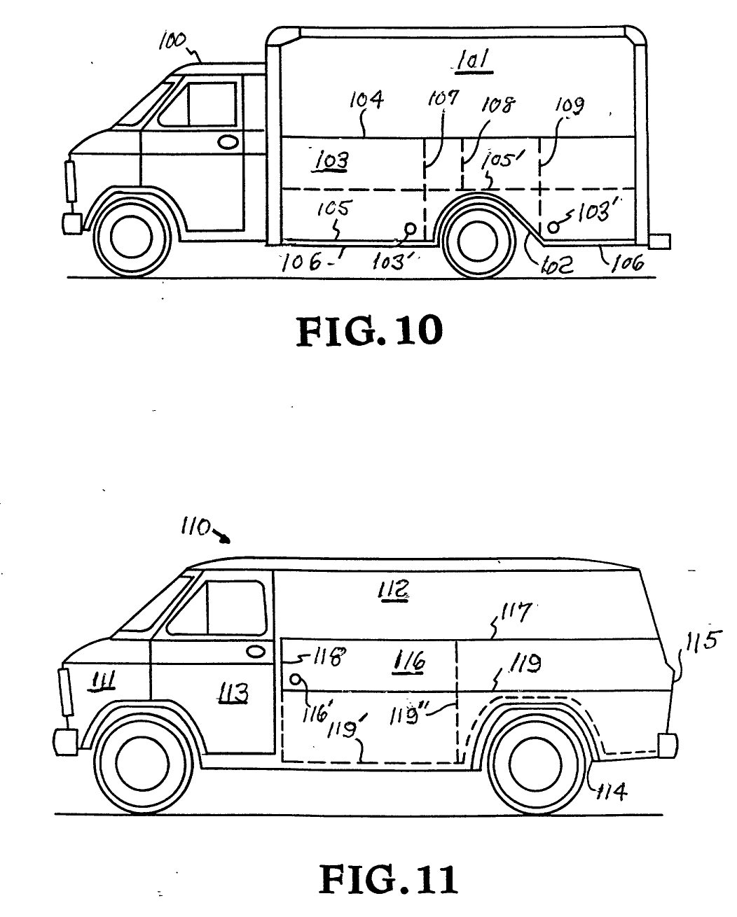

The vehicle, such as illustrated in FIGS. 1-7, as well as the larger type vans and truck type emergency vehicles as illustrated in FIGS. 10 and 11, may include a plurality of hinged side panel sections which may open upwardly, downwardly or sideways, and one or more of hinged side panel sections may be constructed on the interior thereof to form a work bench, when opened. Various hinged panel section arrangements utilizing the same storage area or box are illustrated in FIGS. 1-17, 35 and 36 and such can be utilized in any of the above identified types of vehicles regardless of the size or type of body or bed. While not illustrated, the hinged side panels have the same external contour as that of a similar vehicle without the hidden storage system. In other words, the hinged side panel sections or hinged fender/side panel sections have a contour corresponding to the remainder of the vehicle's side panels or fender/side panels, or may be designed to compliment an existing vehicle design.

FIG. 9 illustrates a side view of a vehicle similar to FIG. 5 but differs in the configuration of the hinged side panel section. As shown in FIG. 9, the van generally indicated at 92, such as a Dodge Caravan, can be either initially assembled or modified (retrofitted) to include a storage box located behind a hinged side panel section 93, with the storage box and hinged side panel section being configured to extend over a wheel well 94 of van 92. The storage box may be provided with at least one shelf which may be of an adjustable type and/or slideable type, as shown in FIGS. 12 and 13. A seal assembly is utilized to seal out moisture and/or dust when hinged side panel section 93 is closed. If desired, an optional key entry, indicated at 95, may be installed to release the side panel 93. Also, a strut assembly, such as shown in FIGS. 20 and 21, may be utilized to retain the hinged side panel section 93 in open position. The primary difference between FIG. 9 and FIG. 5 is the location of the lower edge of the hinged side panel section. The FIG. 9 embodiment includes a decorative strip 96 located above wheel well 94 and along the side panel of the van, and a lower edge 97 of the hinged side panel section 93 extends adjacent the decorative strip 96 such that when panel section 93 is raised, the decorative strip 96 remains over the wheel well 94 and along the side panel. The hinged side panel section 93 may be modified as described above to include a plurality of hinged sections which may be hinged to be raised or lowered when opened to expose the interior of the storage box within the van 92. The van 92 may include a hidden storage system on both sides thereof.

FIG. 1 is a side view of a truck type emergency vehicle having a cab with an enclosed bed mounted on the vehicle frame behind the cab and with a hidden storage system mounted in one or both sides of the enclosed bed. As shown, the emergency vehicle includes a cab 100 and enclosed bed 101 having wheel wells 102 (only one shown). The hidden storage system, like those described and illustrated in FIGS. 1-9, for example, include a storage box mounted adjacent on one or both sides off the bed or body, or more hinged side panel sections to provide access to the interior of the storage box, and a lock/latch type mechanism for the hinged one or more side panel sections. The height and width of the storage box(s) is dependent on the individual application and thus may vary according to the vehicle on which the storage box(s) are located. Also, the storage boxes may include sections located fore and aft of the wheel wells, as well as above the wheel wells, or may merely extend horizontally along a line above the wheel wells. As shown in FIG. 10, the hidden storage system includes a hinged side panel section indicated at 103 which is located fore, aft and above the wheel well 102 and extends the length of the side panel of the enclosed bed 101. The side panel section 103 is hinged horizontally at an upper edge 104 so that it can be raised to provide access to a storage box therebehind, with the lower edge 105 extending along a floor or frame member 106. The hinged side panel section 103 is provided with a strut assembly, such as shown in FIGS. 20 and 21, for maintaining the panel section 103 in an open position. In this embodiment the storage box may have a height extending from the floor of the enclosed bed 101 to at or above the upper edge 104 of hinged side panel section 103, or having a height from the top of wheel well 102 to at or above the upper edge 104 of panel section 103. Also, the hinged side panel section may also be located above the wheel well, with the lower edge being indicated by dash line 105′. In view of the length of the hinged side panel section 103, it may be preferable to utilize a plurality of hinged sections, as illustrated in FIGS. 8 and 16-17. For example, the hinged side panel section can be cut along the dash line 107 or down the dash lines 108 and 109 to divide the section 103 into either two or three hinged sections. The one or more hinged side panel sections may utilize a lock/latch arrangement, as illustrated in FIGS. 18 and 19, for example, or may utilize closure mechanisms as described hereinafter. If desired, optional key entries indicated at 103′ may be utilized to release the side panel 103. Also, the storage box may include one or more drain/air plug assemblies as well as shelving compartments, as illustrated in FIGS. 12 and 13, for example. As seen in FIG. 10, the only external difference in appearance is the two horizontal cut lines that define the upper and lower edges of the hinged side.

FIG. 11 is a side view of a conventional commercial van having only driver and passenger doors and utilized for various commercial applications as well as emergency vehicles. The van of FIG. 11 includes a hidden storage system similar to that described above with respect to FIG. 10 wherein the hinged side panel section is located above the wheel well and extends from adjacent one or both of the doors to the rear end of the vehicle and includes that taillight assembly. As shown, the van, generally indicated at 110, includes a cab section 111 and a body section 112, with the cab section 111 including a driver's side door 113, and with the body section including a wheel well 114 and a taillight assembly 115. The hidden storage system includes a hinged side panel section 116 which is horizontally hinged at an upper edge 117 and includes a forward edge 118 adjacent door 113 and lower edge 119 such that the side panel section 116 is raised to expose the interior of the storage box or area mounted within the body section 112 on one or both sides thereof. As in FIG. 10, the hinged side panel section 116 can be located above the wheel well 114, and the storage box or area may extend from the floor of the body section 112 fore, aft and over wheel well 114 to or above the upper edge 117 of the hinged side panel section 116, or may extend upwardly from the top of wheel well 114 as described above with respect to FIG. 10. If desired, an optional key entry, indicated at 116′ can be installed to release the side panel 116. In FIG. 11, the taillight assembly 115 is designed to be raised and lowered with hinged side panel section 116, as described with respect to FIG. 8 and FIG. 13. The only change in the external appearance of the van 110 is the cut lines defining the hinged side panel section 116, with the external contour of the body section 112 of van 110 being the same as an identical van without the hidden storage system. If desired, the hinged side panel section 116 can extend to the lower edge of the side panel, as indicated by dash line 119′, which extends around the wheel well 114, and may be below the plane of the floor. Also, the panel section 116 may be divided, as indicated by dash line 119″.

One of the side panels of a vehicle of any of FIGS. 1-11 and 35-36, for example, is shown in detail in FIG. 12 wherein a side panel 120 is illustrated in an open position and retained by a gas lift or strut assembly 121 (only one shown) which may be constructed as shown in FIGS. 20 and 21. As seen in FIG. 12, the side panel assembly 122 additionally includes a storage area or box 123 into which are slideably mounted shelves or box shelves 124 and 125 which are supported by a common support member 126 and include flange section (not shown) which extend into slots in member 126 and in a pair of end support members 127 (only one shown). The adjacent or inner ends of slideable shelves 124 and 125 slide on members 128 secured to the wheel well 129, while the outer or opposite ends of shelves 124 and 125 slide on member 130 (only one shown) secured to ends of the storage area or box 123. The storage area or box 123 is additionally provided with shelf supports 131 and 132 on which a shelf (not shown) can be mounted, whereby the height thereof can be adjusted for various uses. If desired, support members similar to member 127 can be located at 131 or 132 to enable the uses of additional sliding shelves. Also, vertical adjustable shelf supports may be utilized. It is understood that the shelving arrangement of FIG. 12 can also be incorporated into the vehicles of FIGS. 1-11 and 35-36.

FIG. 13 illustrates a side view of a hidden storage system mounted in one or both side panels of a vehicle such as a pickup or a van, as illustrated in FIGS. 1-11. If mounted in the side panel of a pickup, for example, the pickup bed may be constructed as a modular assembly such as illustrated in FIG. 4 with or without the collapsible support members of FIGS. 3 and 4. The side panel of FIG. 13, indicated generally at 134, includes a wheel well 135 and a taillight assembly 136 which is secured to a hinged side panel section 137. The hinged side panel section 137 includes a cut away section 138 that corresponds to and cooperates with the wheel well 135. The side panel 134 includes a storage box 139 which extends over and fore and aft of wheel well 135 and with the fore and aft sections of unhinged sections 140 and 141, defining bins 142 and 143 having hinged lids 144 and 145. The remainder of the storage box provides a space above the bins 142 and 143 and above the wheel well 135 in which shelves or compartments may be installed. As shown in FIG. 13, a sliding shelf 146 is mounted above the wheel well 135, and which may serve as a work top, and a shelf 147 extends along the length of the storage box 139, and which may be of an adjustable type as shown in FIG. 12. The hinged side panel section 137 is retained open by spring type hinge assemblies indicated at 148 and 149, but strut assemblies such as illustrated in FIGS. 20 and 21 may be utilized with one or more horizontally extending hinges along an upper edge of the side panel section 137. While not shown, each of the bins 140 and 141 may be provided with a drain/air relief valve assembly. Also, a seal assembly (not shown) would be located adjacent the periphery of the hinged side panel section 137 when closed, and may be of a heated type. If desired, an optional key entry indicated at 137′ may be installed to release side panel section 137. As shown, the hinged side panel section 137 extends from the forward lip or end of the side panel 134 to the rear end of the bed and includes the taillight section 136 which is electrically connected by an electrical harness (not shown) which allows the taillight section 136 to move with hinged side panel section 137. The side panel 134 and wheel well 135 may include a decorative strip such as illustrated in FIG. 9, and that decorative strip may be constructed to be attached to and move with hinged side panel section 137 or be attached to the wheel well 135 and the fore and aft side panels 140 and 141. If desired, the hinged side panel section 137 may be divided into a plurality of hinged sections such as shown in FIGS. 8 and 16, and such that any one of the hinged sections may be hinged to move upward, downward or sideways.

FIG. 14 illustrates an embodiment of a vehicle bed wherein the side panels include an inner and an outer panel. In this embodiment, the inner panel is partially removed and the outer panel is hinged. While not shown, storage boxes such as boxes 24 and 25 of FIG. 2 having an opening therein to correspond to the removed inner panel section would be secured to the inner panel and to the floor. These storage boxes have been omitted in FIG. 14 in order to illustrate the partial inner panel. As shown, the bed comprises a floor 150, a bulkhead 151, a tailgate 152 and side panels 153 and 154. Each of the side panels consist of an inner panel 155, an outer panel 156 and a top rail 157. As shown, a major portion of the inner panel 155 has been removed, as indicated by the cut lines 158, and the outer panel 156 includes a wheel well cutaway section 159, with the outer panel being horizontally hinged to provide access into the bed from the side. With the bed arrangement of FIG. 14, a bed cover may be installed, and the hinged outer panels 156 provide access to the interior of the bed without removing the cover.

FIG. 15 illustrates an embodiment of a bed wherein the side panels include an inner panel, an outer panel and a top rail as in FIG. 14, but in this embodiment two side panel sections are hinged vertically on each side of the bed with the front hinged panel sections including the inner and outer panels. As shown, a vehicle, such as a pickup truck 160 includes a bed 161 having a floor 162, bulkhead 163, tailgate 164 and side panels 165 and 166 which include a storage area 167 and 168. The storage area may be a pair of storage boxes secured to the side panels as in FIGS. 1-2 or integrated with the side panels as modules as shown in FIGS. 4, 12 and 13. The storage areas 167 and 168 may extend the full length of floor 162. Each of the side panels 165 and 166 include a fender section 169. Side panels 165 and 166 each include a pair of vertically hinged panel sections 170 and 171 and 170′-171′ with the front panel sections 170 and 170′ including an inner panel 172 and an outer panel 173 as described above with respect to FIG. 14, with the rear panel sections 171 and 171′ having only an outer panel 173. A closure mechanism 174 is shown in dotted lines at 175 in panel sections 170 and 170′, the closure mechanism for the rear panel sections 171 and 171′ having been omitted. Thus access to the storage areas 167 and 168 may be gained via either or both of the hinged side panel sections.

FIG. 16 is a top view of a bed, such as the bed of FIG. 8, wherein each side panel of the bed is provided with three sections which provide access to the hidden storage area and illustrates both vertically and horizontally hinged side panel sections. Note that in this bed the storage area extends the full length of the floors. As shown, the bed includes a floor 180, a bulkhead 181, a tailgate 182 and side panels 183 and 184. The side panels include hidden storage areas 189 and 189′ which may be of a modular construction as in FIGS. 4, 12 and 13. Side panels 183 and 184 include three hinged panel sections 185-185′, 187-187′ and 188-188′, with panel sections 185-185′ being hinged vertically to open sideways, as indicated by arrows 186-186′, and with panel sections 187-187′ and 188-188′ being hinged horizontally to open upwardly or downwardly. Note, for example, that if panel sections 188-188′ and 187-187′ are hinged to open downwardly, they may serve as work benches or tables.

FIG. 17 illustrates a top view of a bed similar to FIG. 16 with different side panel section arrangements and with a sliding central compartment on each side. As shown, the bed comprises a floor 190, bulkhead 191, tailgate 192 and side panels 193 and 194. The side panels are provided with front vertically hinged sections 195-195′ which open sideways as indicated by arrows 196-196′, rear horizontally hinged sections 197-197′ are hinged horizontally to open inwardly or downwardly, and central sliding compartments 198-198′ slide outwardly/inwardly as indicated by arrows 199-199′. Storage areas 200-200′ are incorporated into side panels 193-194 as described above relative to FIG. 16.

FIGS. 18 and 19 schematically illustrate embodiments of a mechanical type and an electrical type of latch/lock mechanism for a hidden storage system of a pickup bed such as shown in FIGS. 1-2 and 8, but the latch/lock mechanism can be utilized in the hidden storage system of any of the vehicles of FIGS. 3-17 and 35 and 36. Since the latch/lock mechanism is not visible from an external view of the vehicle, such is considered to be a hidden mechanism and is so defined herein. In the embodiment of FIG. 18, the latch mechanism is cable actuated. As shown, a vehicle indicated at 220 containing a hidden storage system, generally indicated at 221, which includes a storage box as above described and which includes at least one hinged side panel 222 provided with an end gate or rear door or tailgate 223, includes a lock release mechanism generally indicated at 224 having a keyed or keyless lock (not shown) and located at the rear of the storage system and spaced as indicated at 225 from the rear door 223. By this arrangement, the lock release mechanism 224 can be actuated from the inside of the vehicle without opening the end gate or door 223. The latch mechanism constructed of cooperating components are indicated at 226-226′, 227-227′, 228-228′ and 229-229′ with components 226, 227, 228 and 229 secured to the vehicle 220 or storage box within the enclosed area, while cooperating components 226′, 227′, 228′ and 229′ are secured to the inner and lower edge of the hinged side panel 222 such that when the side panel 222 is lowered the components of the latch mechanism interconnect. The components 226-229 each include a movable release member 230 which is actuated by a cable 231 connecting the lock release mechanism 224 via a lever 232 of the lock mechanism 224. Thus, upon movement outwardly of lever 232, as indicated by arrow 233, the cable 231 activates the movable release member 230 where latch components 226′-229′ are released from components 226-229 and the hinged side panel 222 can be raised, as illustrated. To re-secure the side panel 222 when lowered, the lever 232 of lock release mechanism 224 is moved inwardly as indicated by arrow 134 whereby the activation cables 231 and release member 230 enable latch mechanism components 226-229 and 226′-229′ to be re-engaged for retaining the side panel 222 in a secured, closed condition. Various types of mechanical lock/latch mechanisms are commercially available and thus a detailed description of a specific embodiment is deemed unnecessary. However, the lock/latch mechanism should be constructed to prevent the side panel 222 from being easily pried open. Some known lock/latch mechanisms require a 1500 pound pry force to open same.

FIG. 19 illustrates an electrically activated lock/latch mechanism, and is constructed similar to that of FIG. 18 except that electric solenoids and electric leads replace the activation cables of FIG. 18 and the lock release mechanism requires only a push button or key to actuate the latch mechanism via the solenoids. Also, the lock mechanism may be remotely controlled such as by well known vehicle security key/lock systems. As shown in FIG. 19, the lock release mechanism 224′ is located at the rear of the storage box and spaced from the end gate or rear door 223, as indicated at 225. Cooperating latch mechanisms 226-226′, 227-227′, 228-228′ and 229-229′ are mounted on bed 221 and side panel 222 as described above in FIG. 18. Each of latch mechanism components 226, 227, 228 and 229 are provided with a solenoid 236, 237, 238 and 239 which are connected to lock release mechanism 224′ via electrical leads 240, 241, 242, 243 and 244. To release the latch mechanism to enable opening of the side panel 222, the lock release mechanism 224′ is activated such as by a push button, key, or combination as known in the art, which activates solenoids 236-239 thereby moving movable members 230 to allow latch components 226′-229′ to be released from latch components 226-229 allowing side panel 222 to be opened. Since solenoid activated lock/latch mechanisms are well known in the automotive art, further description is deemed unnecessary.

While FIGS. 18 and 19 illustrate embodiments of the lock/latch mechanism with the lock release mechanism 224′ located at the rear of the storage box, the lock release mechanism can be located at the front of the storage box or if an electrical lock/release system is used, as in FIG. 19, the lock release mechanism 224′ can be located in the glove box, behind the driver's seat, or elsewhere in the vehicle. If desired, a key actuated lock release mechanism can be installed in a hinged side panel section but such would be visible from an external view of the vehicle and therefore would not be desirable in that the hidden aspect of the storage system would be reduced.

While the FIGS. 18-19 embodiments have illustrated the use of four (4) latch mechanisms, that number may be less for a single hinged side panel. Where the hinged side panel is composed of side panel sections as in FIGS. 8, 16 and 17, for example, each hinged section should include one or more latch mechanisms, either mechanical or electrical. Also, where the side panel sections are hinged to open downwardly, the location of the cooperating latch mechanism components may be different and, for example, such may be secured to the sides of the hinged side panel sections and to a cooperating location on the storage box.

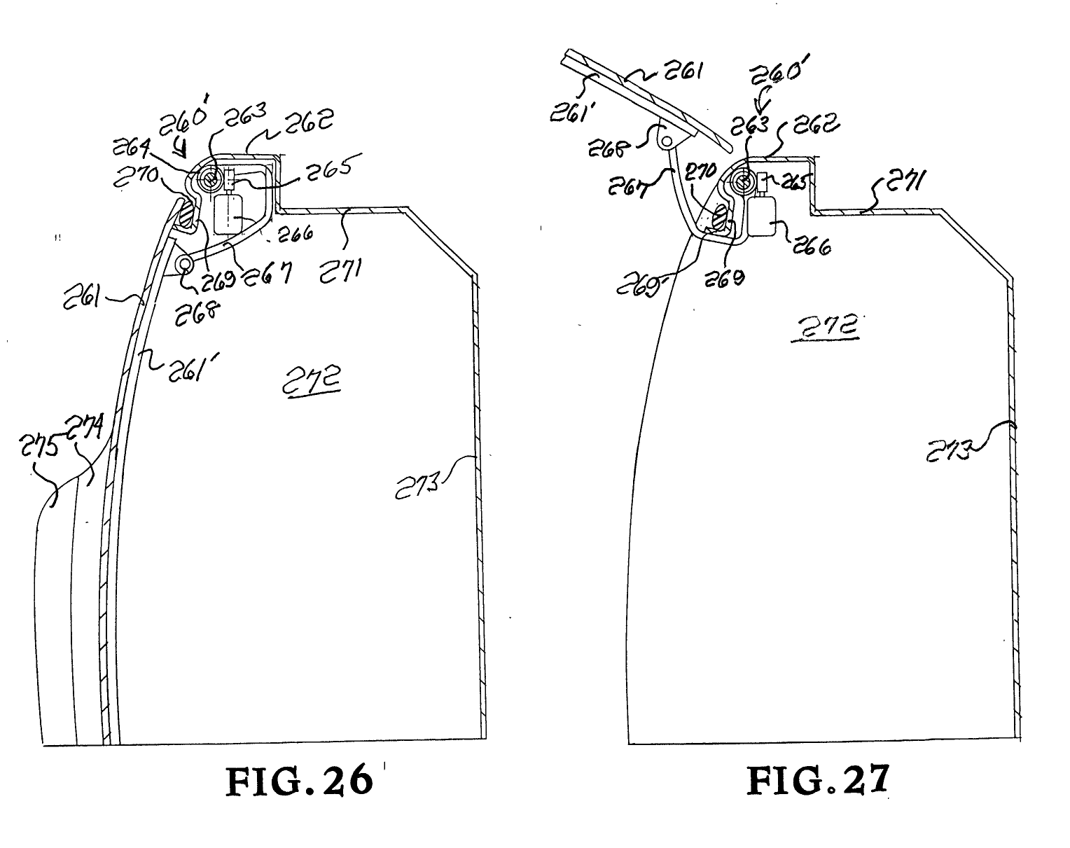

As pointed out above, the upwardly opening side panels are provided with means for retaining same in open position such as by conventional torsion springs or strut assemblies widely used in the automotive field for retaining open rear windows or doors. However, hinges which include spring or mechanically biased means such as shown in FIG. 13, for example, are also commercially available which are constructed to retain a door or window open and thus could be utilized in the hinged side panels, particularly those that are hinged to open downward or sideways. The use of strut assemblies is generally preferred for upwardly opening side panels, but struts have disadvantages when operating in extreme temperature conditions, either hot or cold. This problem is resolved by the strut assemblies illustrated in FIGS. 20 and 26 wherein insulation and/or heating therefor is provided. FIG. 20 illustrates a conventional strut assembly with insulation about the body member while FIG. 21 additionally illustrates an electrical heating strip for a conventional strut. However, the heating strip of FIG. 21 can be incorporated into the insulated strut assembly of FIG. 20. As shown in FIGS. 20 and 21, the strut indicated at 250 comprises a body member 251 having a connector member 252 at one end and a plunger member or rod 253 having a connector member 254 reciprocally mounted in body member 251 and which is sealed in member 251, as known in the art. The body member 251/rod 253 may be provided with a conventional fluid or air arrangement which allows the rod 253 to be moved in or retained in the body member 251. In FIG. 20, the body member 251 is provided with a layer 255 of insulation material and a protective layer or sleeve 256 about the insulation layer. However, depending on the composition of the insulation layer 255, the protective sleeve or layer 256 may not be needed. In FIG. 21, which is constructed as in FIG. 20, the body member 251 is additionally provided with one or more electrical heating strips 257 (only one shown), which would be electrically connected by electrical leads 258 via a thermostat 258′ to the power supply 259 of the vehicle on which the strut is utilized. The electrical heating strip(s) 257 is positioned between the body member 251 and the insulation layer 255 whereby a heated/insulated strut is provided to withstand either extremely high or extremely low temperatures. However, the body member 251 may be provided with one or more heating strips, if desired.

The hidden storage system is constructed such that a variety of storage shelves and/or storage compartments may be positioned in the storage areas on either side of the bed. The storage areas are provided with means by which shelves or compartments may be installed to fit a user's needs. The storage areas may include areas of sufficient length and height for the storage of skis, ski poles, ski boots, and ski clothing, or for the storage of golf club bags and associated equipment or clothing as well as for various tools, parts, etc. Also, the storage areas may be designed to include areas for the storage of shopping purchases whereby such are secured from view—a truck with a trunk.

The hinged side panel sections of the above described embodiments have been described utilizing a closure mechanism composed of latch members controlled by either a mechanical or electrical lock assembly. However, other types of closure mechanisms for a hinged side panel section which may also function as an opening mechanism are described hereinafter with respect to FIGS. 22-24, 28, 30 and 31 and which, like the above described lock/latch mechanisms such as shown in FIGS. 18 and 19 are not exposed to an external view when the side panel sections are closed, and thus are considered to be hidden closure mechanisms.

FIG. 22 illustrates an embodiment of a motor/gear closure mechanism or assembly for a single hinged side panel section such as shown in FIGS. 1-2, 3-4 and 12-14. As shown, the pickup truck bed 201 having a wheel well 202, wheel 203, trim panels 204 and 205, and side panel 206 having a hinged side panel section 207, a portion of which is cut away to illustrate the mechanism for hinging, opening and closing the side panel section located below the upper cap or top rail 208 of side panel 206. Attached to the interior of the side panel 236 is a rod, shaft or bar 209 by supports 210 and on which is mounted a pair of spring type hinges 211 secured to side panel section 207. Also mounted to rod 209 is a gear 212, and mounted within side panel 206 is a reversible electric motor 213 connected to gear 212 by a drive gear 214. Electric motor 213 is electrically connected through a control switch (not shown) to the battery or other electrical power supply (not shown) of the truck on which bed 201 is mounted. Activation of the control switch causes reversible motor 213 to rotate gear 212 causing the rod 209 and hinges 211 to rotate and open the hinged side panel section 207. Spring hinges 211 function to retain the side panel section 207 in an open position. To close the side panel section 207, the control switch is activated to cause reverse drive of the motor 213 and gear 212 to rotate in reverse direction, whereupon the hinged side panel section 207 is closed and retained closed by the motor/gear mechanism. The reversible control switch for the motor 213 may be activated by a remote control mechanism well known in the art. If desired, a motor gear closure mechanism may be mounted in the center or at each end of the side panel.

FIG. 23 illustrates another embodiment of a closure mechanism or assembly which incorporates a pair of torsion springs, and components similar to those of FIG. 22 are given corresponding reference numerals. As shown, a pair of torsion springs 215 and 216 having ends 215′-226′ and 215″-216″ are mounted around rod, bar or shaft 209 with adjacent ends 215′ and 215″ retained in a groove 217 in support member 210′, and ends 216′ and 216″ are retained in grooves 218 of couplers 219 mounted to rod 209. When the hinged side panel section 207 is raised, tension is created in torsion springs 215 and 216 which function to assist in closure of the side panel section 207 and retain same in a closed position. The spring hinges 211 function to retain the side panel section 207 open.

FIGS. 24 and 25 illustrate another embodiment of a motor/gear closure mechanism or assembly wherein a side panel 260 having a hinged side panel section 261 and a top cap or rail 262 is provided with a rod 263 which is mounted in the side panel 260 as in the FIG. 22 embodiment, and to which is mounted a gear 264, drive gear 265 and reversible electric motor 266. Rod 263 is connected by a member 267 via a pivotal connector 268 via a support 261′ to side panel section 261. The top rail 262 includes a curved section 269 in which a seal 270 is mounted and is connected to an end 271 of a wall to form a storage area 272 of the side panel 260. The end 269′ of curved section 269 also functions as a stop for side panel section 261. Activation of the motor 266 rotates member 267 causing the side panel section 2 access to the storage area 272 as shown in FIG. 25, and reverse action of motor 266 closes the panel section 261 as shown in FIG. 24. Operation and electrical connection to motor 266 may be the same described above with respect to FIG. 22. Also, a motor/gear mechanism as shown in FIGS. 24-25 may be mounted in the center or to opposite ends of the side panel section.

FIGS. 26 and 27 illustrate the closure mechanism or assembly of FIGS. 24 and 25 in a larger section of the side panel and corresponding components will be given corresponding reference numerals. The side panel 260 as shown in FIGS. 26 and 27 contains the components of FIGS. 24 and 25 and in addition includes a section of a wall 273 connected to wall end 271 and the top rail 262 to form the storage area 272. Note that the top rail 262 is higher than wall section 271 and thus the top of the storage area may not be seen from an external view of side panel 260, but may be of the same height as the top rail. As seen in FIG. 26, side panel section 261 includes members 274 and 275 which form the contour of the side panel 260 for truck beds having extended wheel wells and/or side panels.

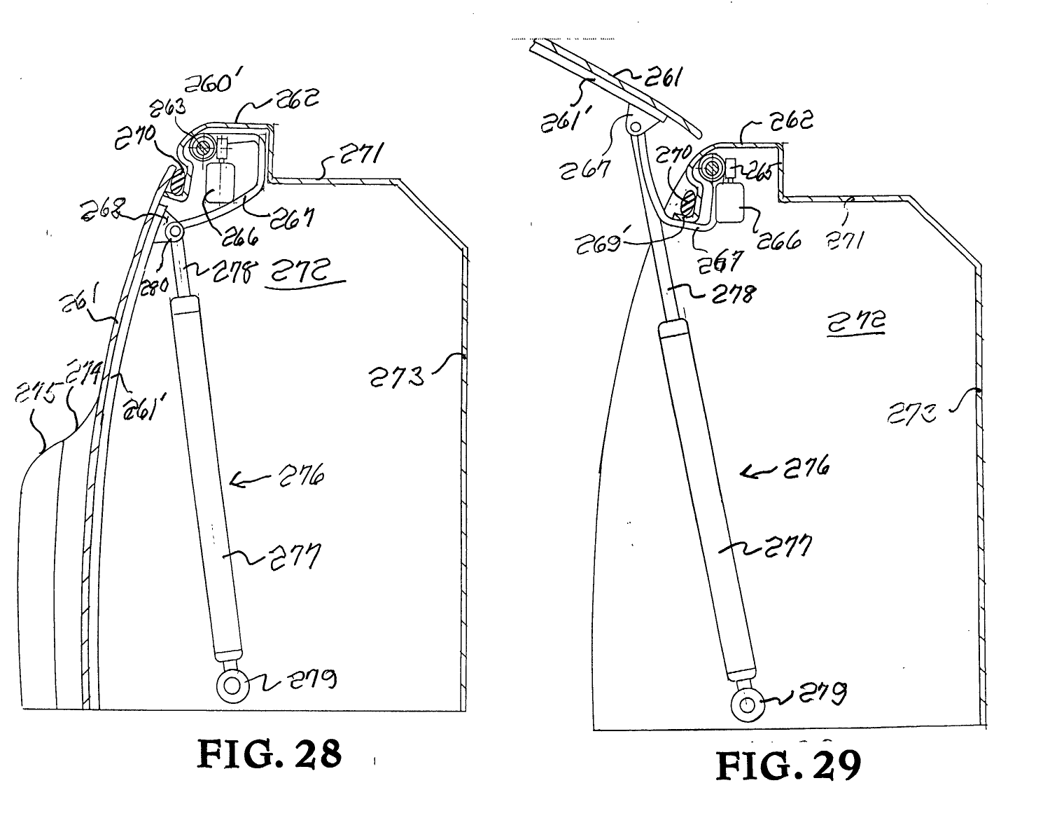

FIGS. 28 and 29 illustrate the embodiment of FIGS. 26 and 27 with the addition of a strut assembly, and corresponding components are given corresponding reference numerals. To the embodiment of FIGS. 26 and 27, a strut assembly 276 having a barrel or body section 277 and a rod or plunger section 278 is pivotably mounted in the side panel 260′ via a connector member 279 of body section 277 and a connector member 280 of rod section 278 which is pivotably mounted to pivotal connector 268. The strut assembly 276 functions to assure that the side panel section 261 remains open, and may be constructed as shown in FIGS. 20 and 21. If desired, a strut assembly may be mounted at each end of the side panel section.

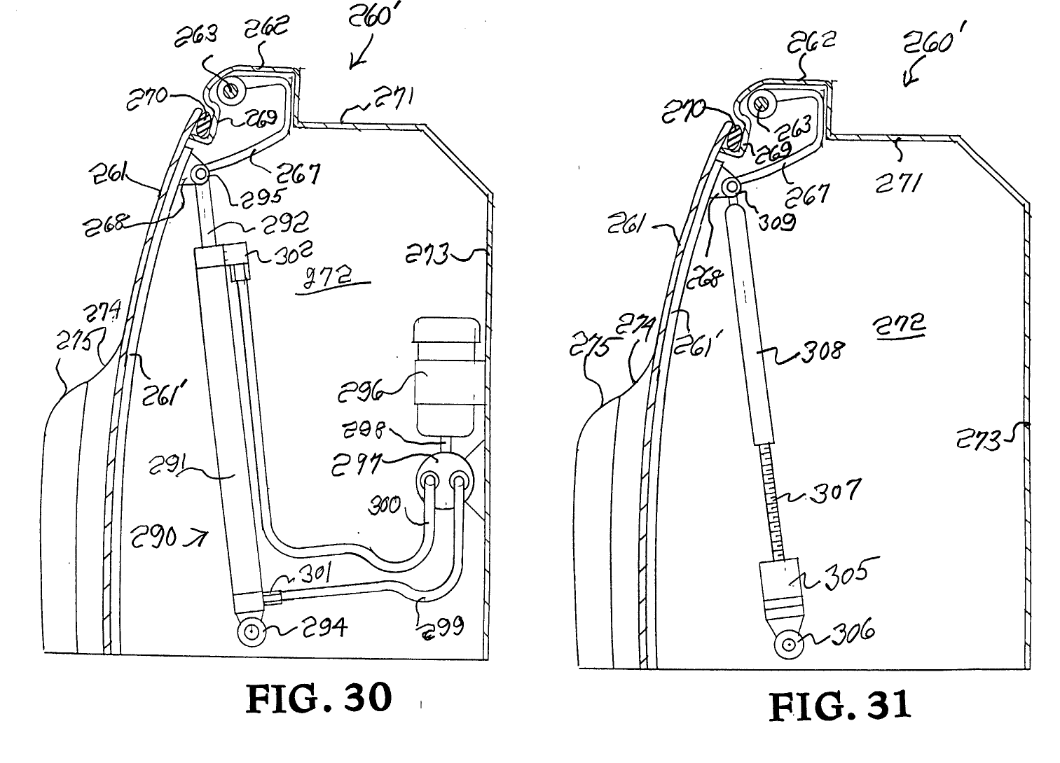

FIG. 30 illustrates another embodiment of a closure mechanism or assembly for the side panel section of a side panel with the side panel being similar to that of FIGS. 26-27 and 28-29, and corresponding components are given corresponding reference numerals. In place of the motor/gear closure mechanism of FIGS. 26-29, a hydraulic closure mechanism or assembly is utilized. As shown, a hydraulic or compressed air cylinder assembly 290 is pivotably mounted to side panel 260′ and to side panel section 261, with cylinder assembly 290 having a body or barrel section 291 and a rod or plunger section 292, with body section 291 having a connector 294 pivotably secured to side panel 260′ and rod section 292 having a connector 295 mounted to the pivotal connector 268. A hydraulic reservoir 296 is mounted to wall 273, and a fluid switch 297 is mounted to wall 273 and connected to reservoir 296 by a line 298. Switch 297 includes two lines or tubes 299 and 300 connected to fluid couplers 301 and 302 mounted at opposite ends of the body section 291 of cylinder assembly 290. In operation, fluid is supplied to line 299 and coupler 301 whereby rod section 292 is driven outwardly causing side panel section 261 to open, and upon switching of fluid switch 297, fluid is directed through line 300 to fluid coupler 302 sand the rod section is moved inwardly closing the side panel section 261 and retaining same in closed position, as shown in FIG. 30. As in the above described embodiments, a hydraulic or compressed air cylinder assembly may be mounted adjacent both ends of the side panel section or in the center thereof.

FIG. 31 illustrates a side panel similar to that of FIG. 30 except for the motor/screw closure mechanism or assembly, and corresponding components are given corresponding reference numerals. As shown in FIG. 31, the motor/screw assembly or closure mechanism comprises a reversible electric motor 305 which is pivotably mounted to side panel 260′ by a connector 306 and is connected to a reversible control switch and power supply (not shown). Motor 305 is connected to a threaded rod or shaft 307 which is threaded into a cylinder 308 having a connector 309 pivotably mounted to pivotal connector 268. As the motor 305 is driven in one direction, the shaft 307 is screwed out of cylinder 308 causing the cylinder 308 to move upwardly and outwardly causing side panel section 261 to open, and reversing of motor 305 causes the reverse action to close the side panel section 261 and maintain same closed, as shown in FIG. 31. It is to be understood that motor 305 is electrically connected via a control switch to a power supply, as described above.

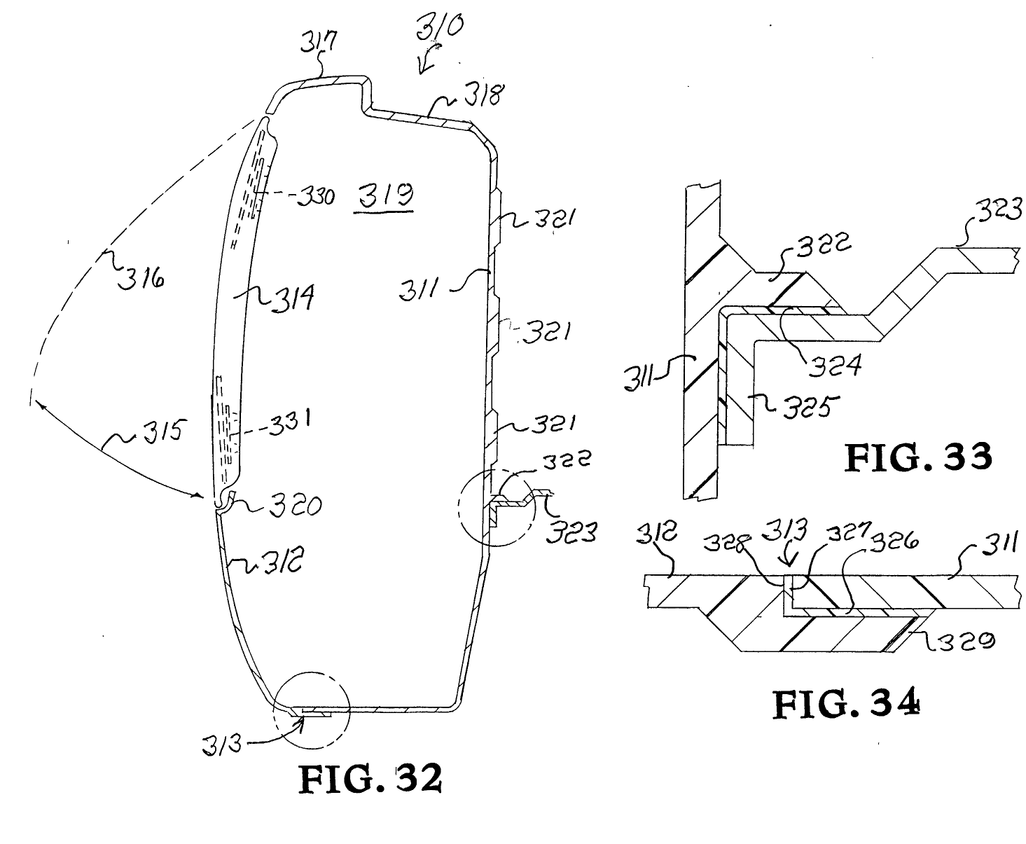

FIG. 32 illustrates in partial cross-section a modular side panel with connector to a floor of a truck bed and an interconnector for connecting to sections forming the modular side panel. The modular side panel 310 is composed of three sections formed in separate molds and interconnected to form a side panel with a hinged side panel section. The three sections comprise two structural sections 311 and 312 interconnected by connector or joint 313 and a side panel section 314 adapted to be hinged or mounted to structural section 311 so as to open outwardly as indicated by arrow 315 and dotted 316 as described above with respect to FIGS. 22-31 and adapted to be closed against structural section 312. Structural member 311 defines a top cap or rail 317 and a section 318 which forms an upper wall of a storage area 319, which is of a lesser height than top rail 317, but may be the same. Structural member 312 includes a curved end section 320 against which the side panel section 314 closes. Structural member 311 includes wider cross-section sections 321 for reinforcement and a longitudinally extending protruding member 322 to which is attached a floor 323 of the bed. Also, the outer (upper) end of structural member 311 may be provided with a curved section such as section 269 of FIGS. 30-31, for example, which functions to retain a seal and as a stop for outward movement of the side panel section.

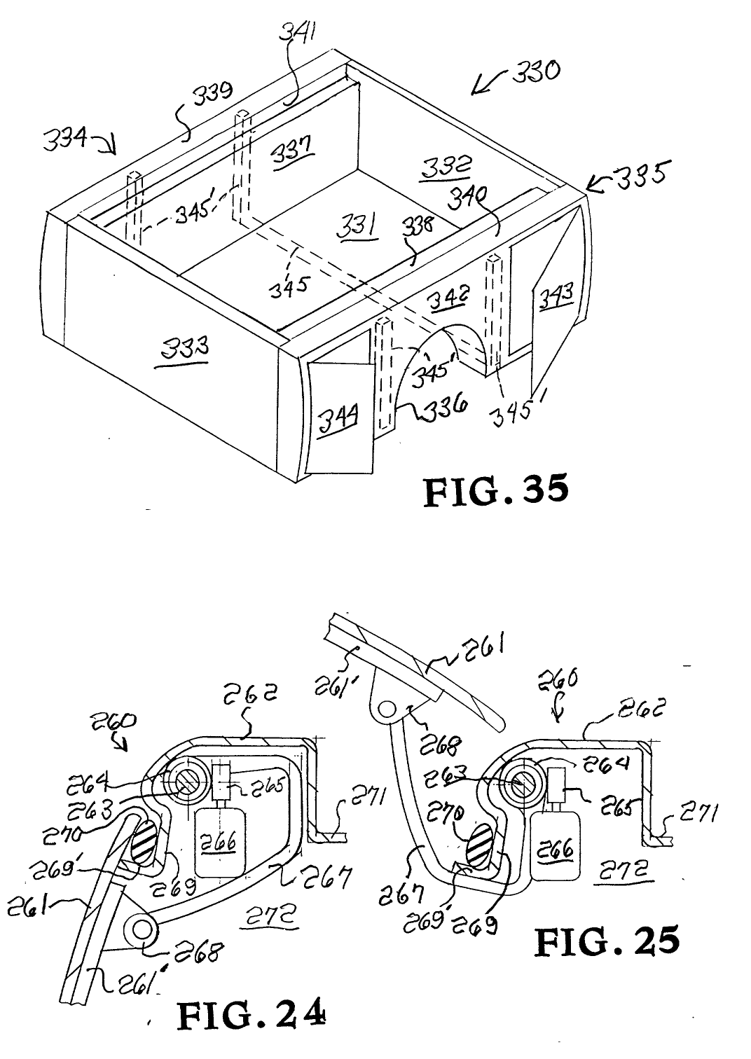

As illustrated by enlargement in FIGS. 33 and 34, the interconnection to bed floor 323 and the connector or joint 313 of structural members 311 and 312 are shown more clearly. As seen in FIG. 33, a bonding seal 324 is located between structural member 311/protruding member 322 and floor 323 which includes a flange 325. As seen in FIG. 34, a bonding seal 326 is located between ends 327 and 328 of structural members 311 and 312 and between structural member 311 and an edge flange 329 of structural member 312. The side panel section 314 may be formed with pockets or other indentations to which covers can be attached for retaining papers, etc., as shown in dotted lines at 330 and 331.

FIG. 35 illustrates a pickup truck bed similar to that of FIG. 14 in that the side panels include an inner panel, an outer panel and a top rail, and is provided with U-shaped support members that extend across and beneath the bed and into the side panels. As shown, the bed 330 comprises a floor section 331, a bulkhead section 332, a tailgate section 333, and two side panel sections 334 and 335 with wheel wells 336 therein (only one shown). Side panel sections 334 and 335 include storage areas 337 and 338 which may be formed integral therewith as a module or as storage boxes attached thereto, as described above. Note that the storage areas 337 and 338 are lower than top rails 339 and 340 or side panel sections 334 and 335. As described above with respect to FIG. 14, inner panels 341 (only one shown) of side panel sections 334 and 335 are partially removed and outer panels 342 (only one shown) include hinged sections 343 and 344 (only shown on one side of the bed). A pair of U-shaped structural support members 345 having end sections 34′ extend across the bed 330 and beneath the floor section 331, with end sections 345′ extending into side panel sections 334 and 335 between inner panels 341 and outer panels 342, as indicated by dashed lines.

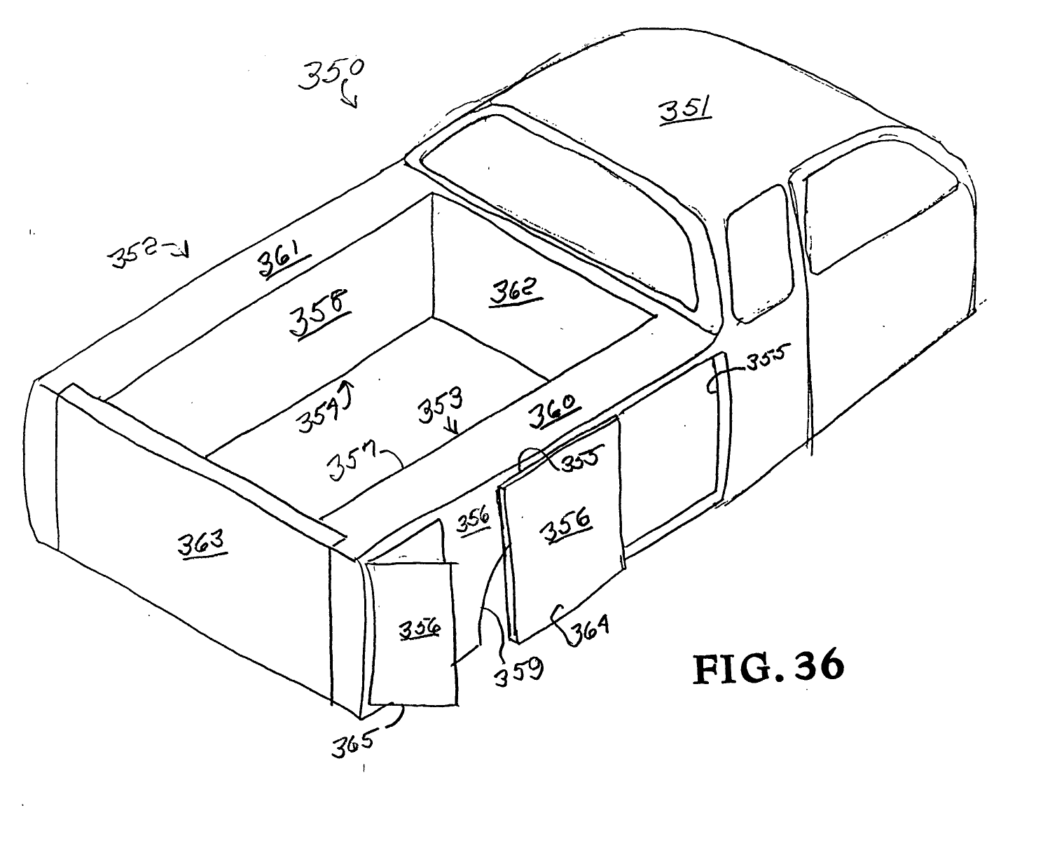

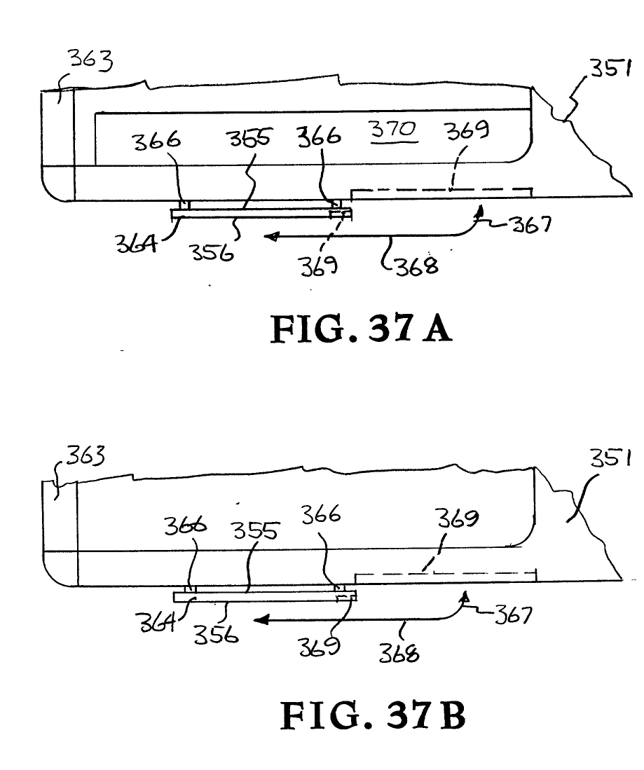

FIGS. 36, 37A and 37B illustrate a pickup truck with a unified cab section and bed section which incorporates the hidden storage system in side panels of the bed section and includes at least one sliding side panel section or door and one hinged side section on at least one side of the bed section. As shown, the truck 350 is composed of unified cab section 351 and bed section 352. The side panels 353 and 354 of bed section 352 are of a construction having an inner panel 355 and an outer panel 356, and includes storage areas 357 and 358 and wheel wells 359 (only one shown). In this embodiment, the storage areas 357 and 358 are of the same height as top rails 360 and 361 of side panels 353 and 354 and extend from a bulkhead 362 to a tailgate 363 of bed section 352. Side panel 353 of bed section 352 is provided with a sliding door 364 shown in open and closed positions in FIGS. 37A and 37B, and a hinged side panel section 365. The sliding door 364 as shown in FIGS. 37A and 37B includes a section of inner panel 355 and a section of outer panel 356, while the hinged side panel section 365 only includes outer panel 356, inner panel 355 having been removed at least in the area of hinged side panel section 365. The sliding door 364 is connected to a track (not shown) by members 366 so as to move outwardly and rearwardly, as indicated by arrows 367 and 368. Sliding doors and track mechanisms therefor are well known and widely utilized in various types of vans, for example, and further description thereof is deemed unnecessary. Sliding door 364 is provided with a hidden (unexposed) lock mechanism 369 but may be provided with a conventional handle (not shown). Hinged side panel section 365 is also provided with latch or closure mechanisms (not shown but as described above). Side panel 354 may also be provided with a similar sliding door and hinged panel section or with other types of hinged panel sections, as described above. FIG. 37A includes a storage box 370 similar to FIG. 2.

While not shown, it is to be understood that the sliding door arrangement of FIGS. 37A and 37B can be incorporated into the vehicle of FIGS. 5-11. In van applications which include a sliding door, the storage box could be mounted adjacent thereto and extend the full height and width of the sliding door.

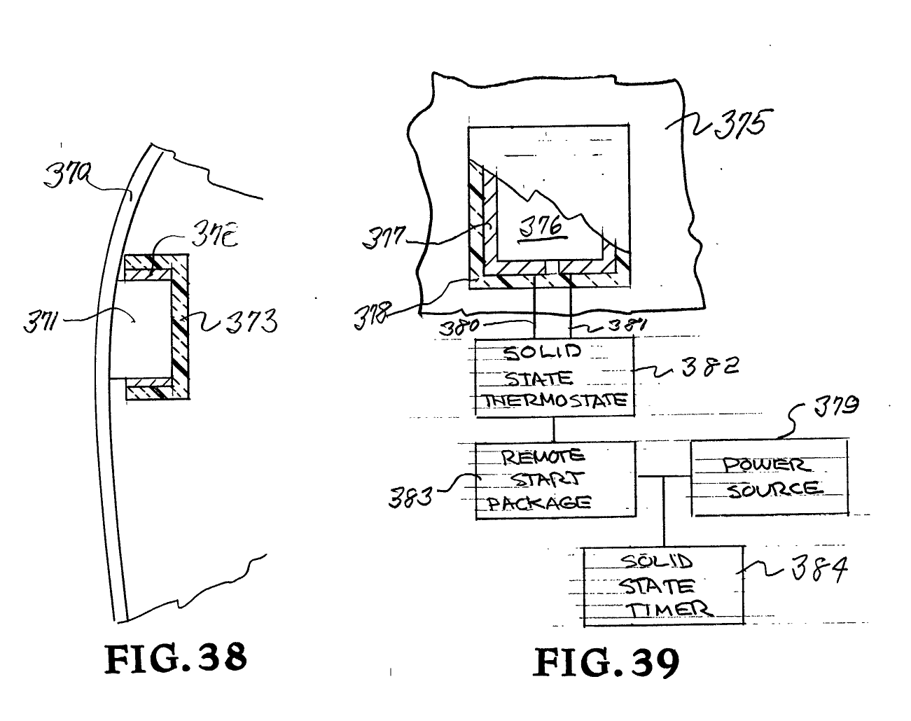

In certain areas, freezing of latch mechanisms and door locks has long been a problem. FIGS. 38 and 39 provide a solution to this problem wherein FIG. 38 is directed to latch mechanism for the hinged side panel sections of the side panel/storage area assemblies and/or modules, and wherein FIG. 39 is directed to door locks having keyed or remote control lock cylinders.

As seen in FIG. 38, a portion of a hinged side panel section 370, such as those shown in any of FIGS. 1 and 4-17, for example, is provided with a latch mechanism 371, such as shown in FIGS. 18, 19 and 36, which is fully or partially surrounded by a heating strip 372 and an insulation layer 373. The heating strip 372 may be activated as described hereinafter with respect to FIG. 39.

As seen in FIG. 39, a vehicle door 375 such as the doors shown in FIGS. 5-7, 9-12 and 36 which conventionally includes a cylinder lock assembly, generally indicated at 376, is surrounded by a heating strip 377 and an insulator layer 378. Heating strip 377 is connected to a power source 379, such as the battery of the vehicle, via lead lines 380 and 381, a solid state thermostat 382 and a remote start package 383, with a solid state timer 384 connected intermediate remote start package 383 and power source 379. Thus, the heating strip 377 can be activated by either the remote start package 383 or the solid state timer 384 whereby any frost on the lock cylinder assembly 376 may be thawed prior to activation of the lock cylinder assembly. Since the components 382-384 are conventionally known in the automotive field and may be obtained as off the shelf items, a detailed description thereof is deemed unnecessary.

While specific embodiments of the hidden storage system with various types of closure mechanisms have been described and/or illustrated, such are not intended to be limiting. For certain vehicles, such as the conventional three-door van, only one side of the vehicle would incorporate a hidden storage arrangement, while other vehicles may include a hidden storage on both sides. The length, depth and height of the storage box or boxes, the storage areas of the modules and the associated hinged or sliding side panel section(s) may vary with the configuration of the vehicle (two door or four door), and if it has windows along the side. Also, the hinged side panel section may or may not include the fender of the vehicle. In addition, depending on the intended use of the vehicle, two or more hinged side panel sections may be used with single or plural storage boxes or storage areas. Thus it has been shown that the present invention provides hidden storage for vehicles, particularly trucks, vans and emergency/utility/sports utility vehicles, with only very minor or no alteration of the external appearance of the vehicle, the only alteration being cut lines defining the edges of the hinged side panel sections. By elimination of the exposed lock/latch or other closure mechanism, the potential for theft is greatly reduced. However, the hinged compartment covers or side panel could be provided with a key slot only, but such would increase the potential for theft.

The vehicle can be modified to incorporate the hidden storage by a conversion or retrofit method, or the hidden storage can be incorporated via an assembly line manufacture of the vehicle or installed utilizing a modular assembly approach. Modifications and changes may become apparent to those skilled in the art, and it is intended that the invention be limited only by the scope of the appended claims.

What is claimed is:

1. In a vehicle having at least a floor and a pair of side panels, the improvement comprising:
a hidden storage area located in at least one of said side panels,
at least a section of said at least one of said side panels being hinged to provide the only access to said hidden storage area, and
a mechanism mounted within at least said one side panel to at least assist in opening and closing said at least one hinged side panel section.

2. The improvement of claim 1, wherein said mechanism includes a motor/gear assembly.

3. The improvement of claim 2, additionally including at least one strut assembly for retaining said at least one hinged side panel section in an open position.

4. The improvement of claim 1, wherein said mechanism includes a torsion spring assembly.

5. The improvement of claim 4, wherein said torsion spring assembly includes a plurality of torsion springs.

6. The improvement of claim 1, wherein said mechanism includes a hydraulic or compressed air cylinder assembly.

7. The improvement of claim 1, wherein said mechanism includes a motor/screw assembly.

8. The improvement of claim 1, wherein said mechanism includes a rod mounted to and within said at least side panel, means for connecting said rod to said at least one hinged side panel section, and means for reversibly rotating said rod to open said at least one hinged side panel section to expose an interior of said hidden storage area, and to close and retain closed said hinged side panel section.

9. The improvement of claim 8, wherein said connecting means comprises at least one spring hinge.

10. The improvement of claim 8, additionally including a plurality of support members for mounting said rod to said at least one side panel.

11. The improvement of claim 8, wherein said reversible rotating means includes a gear mounted to said rod and an electric motor mounted to said at least one side panel for reversibly driving said gear.

12. The improvement of claim 11, wherein said connecting means comprises a member mounted to said rod and pivotably mounted to said at least one hinged side panel section.

13. The improvement of claim 12, additionally including at least one strut assembly pivotably mounted to said at least one side panel and pivotably mounted to said at least one hinged side panel section.

14. The improvement of claim 11, additionally including a drive gear intermediate said gear and said electric motor for reversibly rotating said gear by said electric motor.

15. The improvement of claim 8, wherein said reversible rotating means includes a pair of torsion springs positioned around said rod, a support member for said rod mounted to said at least one side panel, adjacent ends of said pair of torsion springs being mounted to said support member, a pair of connector members mounted to said rod, and opposite ends of said pair of torsion springs being mounted to said pair of connector members.

16. The improvement of claim 15, wherein said connecting means comprises a pair of space spring hinges.

17. The improvement of claim 8, wherein said reversible rotating means includes a hydraulic cylinder assembly, said assembly including a hydraulic cylinder pivotably mounted to said at least one side panel, said hydraulic cylinder having a plunger pivotably mounted to said at least one hinged side panel section, and means for supplying and controlling fluid to opposite ends of said hydraulic cylinder for reversibly moving said plunger.

18. The improvement of claim 8, wherein said reversible rotating means includes a motor pivotably mounted to said at least one side panel, a rotatable threaded member connected to said motor, and a threaded member mounted to and cooperating with said rotatable threaded member and pivotably mounted to said at least one hinged side panel.

19. The vehicle of claim 1, wherein said floor and pair of side panels are mounted to a bulkhead and a tailgate to form a bed.

20. The vehicle bed of claim 19, wherein said bed is integrally connected to a cab of a truck.

21. The vehicle bed of claim 19, wherein each of said side panels of said bed is provided with a hidden storage area and includes at least one hinged side panel section.

22. The vehicle bed of claim 21, wherein each of said side panels is of a modular construction including two interconnected structural sections and a hinged section, said hinged section being constructed to be hinged about one end of one of said two structural sections and constructed to abut against one end of another of said two structural sections.

23. The vehicle bed of claim 22, wherein said one of said two structural sections includes an outwardly protruding section, said outwardly protruding section being adapted to be mounted to said floor of said bed.

24. The vehicle bed of claim 22, wherein said one of said two structural sections includes a section defining a top rail of said side panel.

25. The vehicle bed of claim 22, wherein said mechanism to at least assist in opening and closing said at least one hinged side panel section is mounted within said two interconnected structural sections of said side panels.

26. The vehicle bed of claim 21, wherein each of said side panels of said bed is constructed as a module to include said hidden storage area, said at least one hinged side panel section, and said mechanism for at least assisting in opening and closing said at least one hinged side panel section.

27. The vehicle bed of claim 26, wherein each module is provided with at least one shelf therein.

28. The vehicle bed of claim 27, wherein at least one module includes at least one adjustable and/or slideable shelf.

29. The vehicle bed of claim 26, wherein said at least one hinged side panel section extends substantially a length of said side panel.

30. The vehicle bed of claim 26, said at least one hinged side panel section extends the entire length of said side panel.

31. The vehicle bed of claim 26, wherein each module includes a plurality of hinged side panel sections.

32. The vehicle bed of claim 31, wherein said plurality of hinged side panel sections are selected from the group consisting of horizontally hinged sections, vertically hinged sections and slideable sections.

33. The vehicle bed of claim 31, wherein each module includes at least one hinged side panel section and at least one slideable compartment.

34. The vehicle bed of claim 21, additionally including means for retaining said at least one hinged side panel section in an open position.

35. The vehicle bed of claim 34, wherein said means comprises at least one strut assembly.

36. The vehicle bed of claim 21, additionally including a lock/latch mechanism for retaining said at least one side panel section in a closed position.

37. The vehicle bed of claim 36, wherein said lock/latch mechanism is hidden from view and is either mechanically or electrically actuated.

38. The vehicle bed of claim 21, wherein each of said side panels of said bed is composed of an inner panel and an outer panel, wherein at least a portion of the inner panel is removed, and wherein said hidden storage area comprises a storage box having an opening therein with said opening positioned adjacent the inner panel.

39. The vehicle bed of claim 38, wherein each of said side panels of said bed includes a plurality of hinged sections, at least one of said hinged sections including a section of said inner panel and a section of said outer panel.

40. The vehicle of claim 39, wherein each of said side panels of said bed includes at least one sliding door.

41. The vehicle bed of claim 21, additionally including at least one collapsible support beam located beneath said floor and extending into each of said side panels.

42. The vehicle bed of claim 41, wherein said collapsible support beam includes a hollow central section and a pair of end sections extending into and breakably secured to said hollow central section.

43. In a vehicle having contoured side panels, a hidden storage system comprising:
at least one hinged contoured side panel section,
at least one storage box having an interior located adjacent said at least one hinged contoured side panel section, and
a mechanism for opening, closing and retaining closed said at least one hinged contoured side panel section,
said hidden storage system being constructed to not substantially alter an external appearance of the contoured side panels of the vehicle.

44. The vehicle of claim 43, wherein said mechanism is selected from the group consisting of motor/gear, torsion spring, hydraulic, compressed air, and screw driven.

45. The vehicle of claim 43, additionally including at least one strut assembly for retaining said at least one hinged contoured side panel section in an open position.

46. The improvement of claim 1, additionally including means for retaining said at least one hinged side panel section closed, and means for heating said said retaining means.

47. The improvement of claim 46, wherein said means for retaining comprises a latch/lock mechanism which is mechanically or electrically controlled.

48. The vehicle bed of claim 21 mounted on a truck having at least one door therein, said at least one door including a cylinder lock and means for heating said cylinder lock.

49. The vehicle of claim 43, wherein at least one of said contoured side panels includes at least one hinged door for entry into the vehicle, said at least one hinged door includes a cylinder lock and means for heating said cylinder lock.

50. The vehicle of claim 49, wherein said at least one contoured said panels and said at least one hinged door form a side of a vehicle selected from the group consisting of vans, sports utility vehicles, emergency vehicles, and trucks having a unified cab/bed.
